(19) United States
(12) Patent Application Publication
(10) Pub. No.: US 2008/0304558 A1
(43) Pub. Date: Dec. 11, 2008

(54) HYBRID TIME-FREQUENCY DOMAIN EQUALIZATION OVER BROADBAND MULTI-INPUT MULTI-OUTPUT CHANNELS

(75) Inventors: Yu Zhu, Kowloon (HK); Khaled Ben Letaief, Kowloon (HK)

Correspondence Address: AMIN, TUROCY & CALVIN, LLP, 127 Public Square, 57th Floor, Key Tower, CLEVELAND, OH, 44114, US

(73) Assignee: HONG KONG UNIVERSITY OF SCIENCE AND TECHNOLOGY, Kowloon (HK)

(21) Appl. No.: 11/758,873

(22) Filed: Jun. 6, 2007

(51) Int. Cl. H04L 27/01; H04L 12/28

(52) U.S. Cl. 375/233; 375/260

(57) ABSTRACT

A system and methodology for channel equalization are provided. According to one aspect, a receiver structure for a MIMO system is provided that employs frequency domain equalization (FDE) with noise prediction (FDE-NP). The FDE-NP structure may include a feedforward linear frequency domain equalizer and a group of time domain noise predictors (NPs), which may operate by predicting a distortion corresponding to a given linearly equalized data stream based on previous distortions of all linearly equalized data streams. According to another aspect, a receiver structure for a MIMO system is provided that employs FDE-NP with successive interference cancellation (FDE-NP-SIC), which can extend the functionality of FDE-NP by ordering all linearly equalized data streams according to their minimum mean square errors (MMSEs) and detecting those streams which have a low MMSE first, thereby allowing current decisions of lower-indexed streams to be considered along with previous decisions for all data streams for noise prediction. According to a third aspect, a method for analyzing the performance of a MIMO system with equalization is provided. Pursuant to the method, a general expression of MMSE may first be derived. The MMSE expression may then be related to an error bound by applying the modified Chernoff bounding methodology in a general MIMO system. The parameters in the result may then be varied for applicability to single-input single-output (SISO), multiple-input single-output (MISO), and single-input multiple-output (SIMO) systems with receiver equalization technology.

### TECHNICAL FIELD

The subject invention relates generally to wireless communications, and more particularly to techniques for channel equalization in a wireless communication system.

### BACKGROUND OF THE INVENTION

Multi-input multi-output (MIMO) technology involves the employment of multiple antennas at both a transmitter and a receiver in a wireless communication system. Such technology has recently received significant recognition as a fundamental scheme for increasing diversity gain and enhancing system capacity in a wireless communication system. However, when a MIMO system is operated over a multipath fading channel, its performance can be severely degraded. Traditionally, orthogonal frequency-division multiplexing (OFDM) is used to mitigate this performance degradation by converting a frequency-selective MIMO channel into a set of parallel frequency-flat fading MIMO channels. However, OFDM has several inherent disadvantages. For example, the power of signals transmitted in a system utilizing OFDM will often have high peak-to-average ratios (PAR). In addition, OFDM is sensitive to carrier frequency offsets (CFO).

Another traditional approach to mitigating performance degradation due to multipath fading is single carrier frequency domain equalization (SC-FDE). Prior experimentation has shown that SC-FDE can perform similarly to OFDM and better than OFDM in some cases while having almost the same signal processing complexity as OFDM. Additionally, prior experimentation has shown that the single-carrier transmission used in SC-FDE allows said approach to operate with fewer inherent disadvantages than OFDM. This approach has been adopted in the IEEE 802.16 standard, and it has also been considered for use in the Third Generation Partnership Project-Long Term Evolution (3GPP-LTE) protocol. This approach has also been extended to single carrier frequency domain linear equalization (FD-LE), which is based on the Zero-Forcing or minimum mean-square-error (MMSE) criterion for MIMO systems.

SC-FDE has further been extended to hybrid time-frequency domain decision feedback equalization (FD-DFE) for MIMO systems, wherein a feedforward frequency domain equalizer (FDE) is used in connection with a group of time domain feedback filters to eliminate part of the post-cursor inter-symbol interference (ISI) and co-channel interference (CCI) of one or more data streams. In a conventional variation of FD-DFE adapted from layered spatial-time domain equalization, a layered spatial-frequency domain equalization structure is utilized, wherein a basic FDE is employed at multiple stages and multiple data streams are detected according to a layered approach. Layered spatial-frequency domain equalization has also conventionally been combined with iterative processing, wherein an iterative block DFE is utilized in a layered FDE MIMO system.

However, the FD-DFE approach and its variants also have inherent disadvantages. First, the feedforward FDE and feedback filters utilized by FD-DFE are traditionally jointly designed, which can make a system using such an approach difficult to modify. For example, if the structure of a feedback filter corresponding to a particular data stream in a system utilizing FD-DFE must be changed, then the coefficients of the feedforward FDE and all of the other feedback filters must also be updated. This rigidity may also lead to increased signal processing complexity and reduced system design flexibility. In addition, it has traditionally been difficult to utilize FD-DFE in cooperation with a channel decoder due to the lower reliability of instantaneous hard decisions prior to the channel decoder. As a result, systems utilizing the traditional FD-DFE approach may not obtain a significant benefit from channel coding. Further, the feedback filters employed in a traditional FD-DFE system may not make the most efficient use of all information available to them, thereby leading to an additional loss of system performance.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The subject invention provides a system and methodology for channel equalization in a MIMO communication system. In accordance with one aspect of the invention, a receiver structure for a MIMO system is provided that employs FDE with noise prediction (FDE-NP). The FDE-NP structure may include a feedforward linear FDE and a group of time domain noise predictors (NPs). As demonstrated herein, the provided FDE-NP structure is an optimal design in the MMSE sense and has the same resulting MSE as the conventional FD-DFE scheme. Further, the provided FDE-NP structure can be used in connection with the IEEE 802.16 standard and the 3GPP-LTE protocol in a similar manner to FD-DFE. However, unlike the conventional FD-DFE approach, the feedforward FDE and the feedback NPs can be separately optimized. This characteristic of the FDE-NP structure significantly reduces signal processing complexity and allows greater flexibility of receiver design over conventional approaches. For example, the FDE-NP structure can allow reliable detection of different data streams while guaranteeing their own quality of service (QoS) requirements through the use of different NPs' orders. This and other performance/complexity trade-offs can be easily achieved using the FDE-NP structure by dynamically changing the structure of the NPs without affecting the feedforward FDE. Additionally, block interleaving and deinterleaving may be utilized in connection with the provided FDE-NP MIMO scheme to allow cooperation with a channel decoder. For example, post-decoded decisions from a channel decoder, which may have more reliability than instantaneous hard decisions prior to the decoder, can be fed back to the NPs.

According to another aspect of the invention, a receiver structure for a MIMO system is provided that employs FDE-NP with successive interference cancellation (FDE-NP-SIC). Under the provided FDE-NP structure, previous decisions of all data streams are fed back to the NPs for noise prediction. The provided FDE-NP-SIC structure can extend the functionality of FDE-NP by ordering all data streams according to their MMSEs and detecting those streams which have low MMSEs first. Thus, current decisions of lower-indexed streams can be considered along with the previous decisions of all data streams for noise prediction. By considering current decisions of lower-indexed data streams along with the previous decisions of the data streams, the FDE-NP-SIC scheme can perform significantly better than the conventional FD-LE and FD-DFE schemes.

According to an additional aspect of the invention, a method for analyzing the performance of a MIMO system with equalization is provided. Pursuant to the provided method, a general expression of MMSE may first be derived. This expression of MMSE may be applicable for the conventional FD-LE and FD-DFE MIMO schemes as well as the provided FDE-NP and FDE-NP-SIC MIMO schemes. The MMSE expression may then be related to an error bound by applying the modified Chernoff bounding methodology in a general MIMO system. By varying the parameters in the result, the bound can be further deduced and applied to single-input single-output (SISO), multiple-input single-output (MISO), and single-input multiple-output (SIMO) systems with receiver equalization technology. As demonstrated herein, the provided method yields an error bound that can be substantially similar to simulated results at reasonable SNR values. Thus, the provided method can prove to be useful in performance analysis, evaluation, and design of these important systems.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a high-level block diagram of a multiple-input multiple-output communication system in accordance with an aspect of the present invention.

FIG. 2A is a block diagram of an exemplary receiver structure that can employ frequency domain equalization with noise prediction in accordance with an aspect of the present invention.

FIGS. 2B and 2C are block diagrams of exemplary feedback noise predictors in accordance with an aspect of the present invention.

FIG. 3A is a block diagram of an exemplary receiver structure that can employ frequency domain equalization with noise prediction and successive interference calculation in accordance with an aspect of the present invention.

FIG. 3B is a block diagram of an exemplary feedback noise predictor in accordance with an aspect of the present invention.

FIG. 4 is a flowchart of a method for analyzing the performance of a multiple-input multiple-output system with equalization in accordance with an aspect of the present invention.

FIG. 5 illustrates performance data for an exemplary multiple-input multiple-output communication system with equalization in accordance with an aspect of the present invention.

FIGS. 6-9 illustrate comparisons between performance data for exemplary multiple-input multiple-output communication systems in accordance with various aspects of the present invention and performance data for conventional communication systems.

FIG. 10 is a flowchart of a method of hybrid time-frequency domain equalization with noise prediction in a multiple-input multiple-output communication system in accordance with an aspect of the present invention.

FIG. 11 is a flowchart of a method of hybrid time-frequency domain equalization with noise prediction and successive interference cancellation in a multiple-input multiple-output communication system in accordance with an aspect of the present invention.

FIG. 12 is a block diagram representing an exemplary non-limiting computing system or operating environment in which the present invention may be implemented.

FIG. 13A illustrates an overview of a network environment suitable for service by embodiments of the present invention.

FIG. 13B illustrates a GPRS network architecture that may incorporate various aspects of the present invention.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. As another example, a component may comprise one or more logical modules implemented on a hardware device such as a field-programmable gate array (FPGA), a digital signal processor (DSP), an application-specific integrated circuit (ASIC), and/or any other integrated circuit device or suitable hardware device. By way of illustration, both an application running on a server and the server can be a component. One or more components may reside within a process and/or thread of execution and a component may be localized on one computer and/or distributed between two or more computers. Also, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The components may communicate via local and/or remote processes such as in accordance with a signal having one or more data packets (e.g., data from one component interacting with another component in a local system, distributed system, and/or across a network such as the Internet with other systems via the signal).

Further, as used in this application, capital letters denote entities in the frequency domain and lowercase letters represent entities in the time domain. Further, bold letters denote matrices and column vectors, I_{N} denotes an N-by-N identity matrix, and 0_{N×M} denotes an N-by-M zero matrix. In addition, the operator (.)modN denotes the modulo-N operation, and the superscripts (.)^{T}, (.)*, and (.)^{H} represent transpose, complex conjugate, and complex conjugate transpose, respectively. Moreover, tr{.} denotes the trace of a square matrix and E{.} denotes the expectation operation.

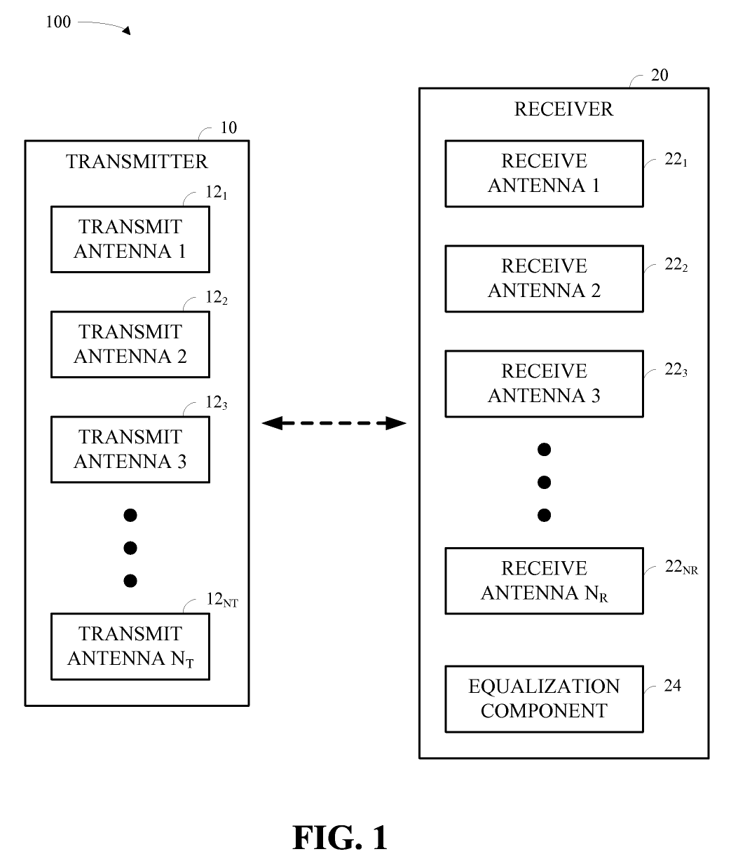

Referring to FIG. 1, a high-level block diagram of a multiple-input multiple-output (MIMO) communication system 100 in accordance with an aspect of the present invention is illustrated. In one example of the present invention, system 100 includes a transmitter 10 having N_{T} transmit antennas 12, each of which may transmit an independent data stream via a single-carrier block transmission. Data streams transmitted by the transmit antennas 12 may travel through frequency selective channels and may then be received at a receiver 20 having N_{R} receive antennas 22. While only one transmitter 10 is illustrated in system 100 for brevity, it should be appreciated that system 100 could include any number of transmitters 10. By way of non-limiting example, a transmitter 10 may be an access terminal, user equipment, a mobile device, or any other appropriate transmitting entity. Additionally, the receiver 20 may be a base station, a system access point, or any other suitable receiving entity.

In one example of the present invention, the data stream transmitted by each transmit antenna 12 can consist of N symbols, all of which may be packed and transmitted by each respective transmit antenna 12 in a single block. Accordingly, the symbols transmitted in one block in an i-th data stream corresponding to an i-th transmit antenna 12 may be expressed as x_{n,i}, where n=0, . . . N−1. Further, the average energy of the symbols transmitted in one block of the i-th data stream may be expressed as σₓ². In another example, the frequency selective fading channels through which the N_{T} transmit antennas 12 and the N_{R} receive antennas 22 communicate can be uncorrelated to each other and may have a time-invariant impulse response with a memory of L symbols in a given block transmission period and a varying impulse response in another block. Additionally, data corresponding to a given block may include a cyclic prefix (CP). A CP corresponding to a given block may be inserted in front of the block prior to transmission of the block by the transmit antennas 12 to remove inter-block interference and to make the linear convolution associated with a channel over which the block is communicated equivalent to a circular convolution. In accordance with one aspect of the present invention, each channel in the system 100 may have a maximum channel impulse response length of L corresponding to a memory of L symbols employed by each channel for a given block transmission period. Accordingly, a CP for a given block may have a minimum length of L−1 symbols in order to provide a desired level of functionality. In the case of a CP that is L−1 in length, the total data transmission efficiency for a given block may then be expressed as N/(N+L−1).

In another example of the present invention, baseband signals received by the receiver 20 from the transmitter 10 at a given time n can be expressed as the vector yₙ=[y_{n,1} . . . y_{n,N}_{_{R}}]^{T}, where y_{n,j} represents a signal received by aj-th receive antenna 22 at the receiver 20 at time n. Further, the signals received at the receiver 20 at time n can be given by the following equation:

$${y}_{n} = {\sum }_{m = 0}^{N - 1} {h}_{m} {x}_{( n - m ) mod N} + {v}_{n} n = 0 , 1 , … , N - 1 , \qquad ( 1 )$$

where the equivalent discrete-time baseband MIMO channel model is applied and hₘ is an N_{R}-by-N_{T} matrix having entries h_{m,ij} that correspond to the m-th channel impulse response from aj-th transmit antenna 12 to an i-th receive antenna 22. Further, it should be appreciated that when m≧L, hₘ is a zero matrix. Additionally, vₙ in Equation (1) is a vector representing additive white Gaussian noises from all N_{R} receive antennas 22.

In accordance with one aspect, the noise components of the received signals at each receive antenna 22 may have the same variance, which may be expressed as σᵥ². A discrete Fourier transform (DFT) may then be defined as

$${X}_{k} = ( 1 / \sqrt{N} ) {\sum }_{n = 0}^{N - 1} {x}_{n} {e}^{- j2π nk / N} for k = 0 , … , N - 1 ,$$

where xₙ and xₖ are a time domain sequence and its corresponding frequency domain sequence, respectively. By applying the DFT operation to each element of yₙ, yₙ can be expressed in the frequency domain as follows:

Yₖ=HₖXₖ+Vₖ k=0, 1, . . . , N−1, (2)

where Hₖ is an N_{R}-by-N_{T} matrix that represents channel frequency response at a k-th tone. Matrix Hₖ may be composed of entries H_{k,pq}, which may be expressed as follows:

$${H}_{k , pq} = {\sum }_{n = 0}^{N - 1} {h}_{n , pq} {e}^{- j \frac{2 π}{N} nk} . \qquad ( 3 )$$

In one example, the above DFT operation can be implemented by using efficiently by using a fast Fourier transform (FFT) operation. Additionally, the frequency domain expression given by Equation (2) may be converted back to the time domain by using an inverse discrete Fourier transform (IDFT) operation, which may be implemented by using an inverse fast Fourier transform (IFFT) operation. In another example, the respective elements of matrices Xₖ and Vₖ may have a uniform variance. Thus, the variance of X_{k,i}, which is the i-th element of Xₖ, may be expressed as σₓ², and the variance of V_{k,i}, which is the i-th element of Vₖ may be expressed as σᵥ².

In accordance with another aspect of the invention, the receiver 20 can further include an equalization component 24 to mitigate signal degradation present in the data streams received from the transmitter 10 due to multipath fading. In one example, the equalization component 24 can utilize frequency domain equalization with noise prediction (FDE-NP), wherein linear equalization is performed on the received signals in the frequency domain and then noise prediction is performed on the linearly equalized data streams in the time domain. The noise prediction may be performed for a given linearly equalized data stream, for example, by predicting the distortion in a linearly equalized data stream at a given time according to previous distortions of all linearly equalized data streams. In another example, the equalization component can utilize FDE-NP with successive interference cancellation (FDE-NP-SIC). FDE-NP-SIC can function as an extension of FDE-NP, wherein the linearly equalized data streams are ordered and indexed according to their MMSEs in the time domain after equalization is performed on the linearly equalized data streams in the frequency domain. Noise prediction may then be performed on the ordered and indexed linearly equalized data streams in the time domain. By first ordering and indexing the linearly equalized data streams before performing noise prediction, the distortion in a given linearly equalized data stream can be predicted based on previous distortions of all linearly equalized data streams as well as current distortions of lower-indexed linearly equalized data streams.

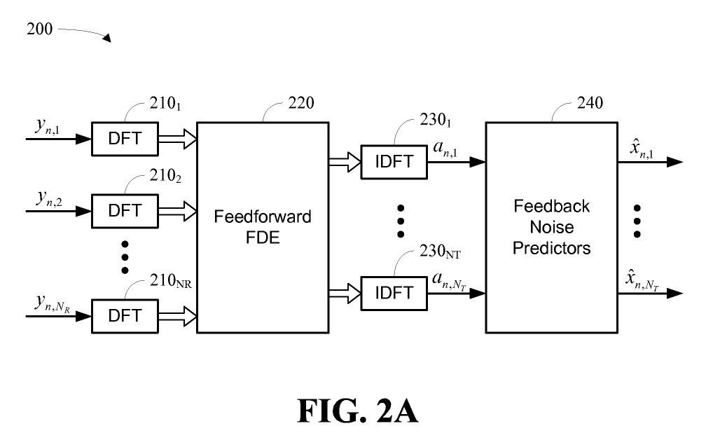

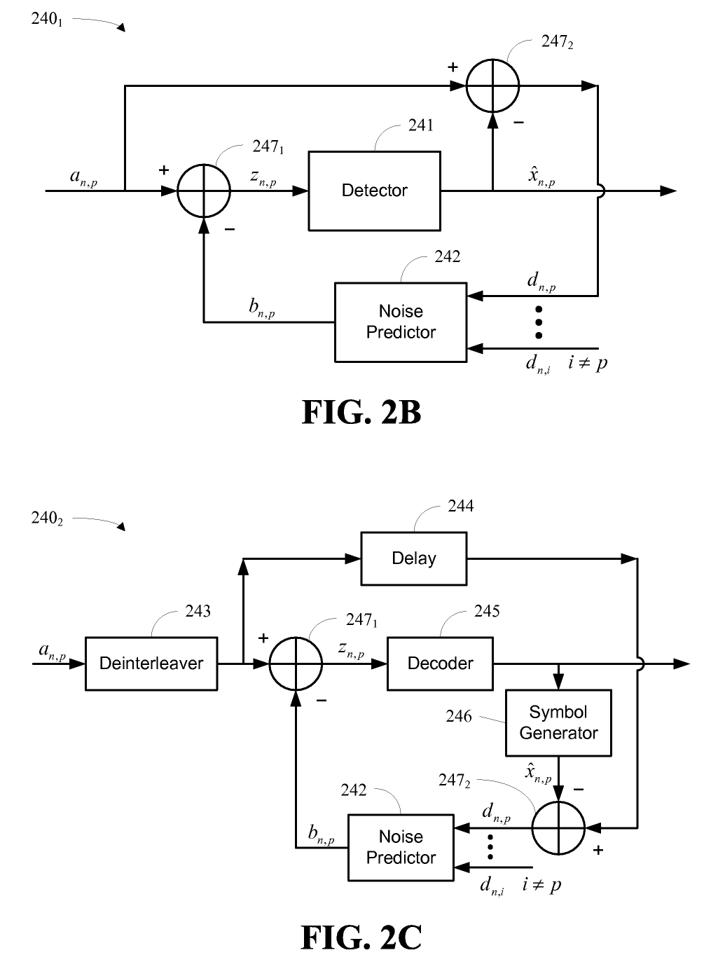

Referring now to FIG. 2A, a block diagram of an exemplary receiver structure 200 in accordance with an aspect of the present invention is illustrated. By way of non-limiting example, receiver structure 200 may be implemented as an equalization component (e.g., an equalization component 24) at a receiver (e.g., a receiver 20). In one example of the present invention, receiver structure 200 is operable to perform channel equalization on received signals from respective receive antennas (e.g., signals received from receive antennas 22 at a receiver 20) based on an FDE-NP scheme. By way of non-limiting example, an FDE-NP scheme may be implemented by receiver structure 200 as follows. First, an input vector yₙ corresponding to signals received at N_{R} receive antennas (e.g., receive antennas 22) can be converted to the frequency domain by using a DFT operation at blocks 210. Feedforward equalization may then be performed in the frequency domain by a frequency domain equalizer (FDE) 220 at a k-th frequency tone by multiplying an N_{T}-by-N_{R} matrix Wₖ to the input vector Yₖ. The resulting vector Aₖ may then correspond to N_{T} data streams transmitted to the receiver (e.g., by N_{T} transmit antennas 12 at a transmitter 10). This may be expressed as follows:

Aₖ=WₖYₖ k=0,1, . . . , N−1. (4)

After equalization is performed by the feedforward FDE 220, the vector Aₖ can be converted back to the time domain by performing an IDFT operation at blocks 230. By then substituting Equation (2) into Equation (4) Aₖ can be expressed in the time domain as follows:

$${a}_{n} = \frac{1}{\sqrt{N}} {\sum }_{k = 0}^{N - 1} {W}_{k} ( {H}_{k} {X}_{k} + {V}_{k} ) {e}^{j \frac{2 π}{N} kn} . \qquad ( 5 )$$

After the conversion at blocks 230 is performed, the time domain vector aₙ may be passed to feedback noise predictors (NPs) 240. In accordance with one aspect of the present invention, the NPs 240 can predict the distortion in each entry of aₙ at time n, which may be expressed as an a_{n,p} for a given data stream p, according to previous distortions from all data streams. Additionally and/or alternatively, the NPs 240 can predict the distortion in each entry an a_{n,p} based on the post-cursor inter-symbol interference (ISI) of the entry itself as well as the post-cursor co-channel interference (CCI) coming from other data streams. To simplify the operation of the NPs 240, it may be assumed that all NPs 240 have the same order B, thereby allowing the coefficients of NPs 240 corresponding to different data streams to be derived together in a matrix and vector form. Thus, the and the data vector zₙ prior to detection by the NPs 240 can be represented as follows:

$${z}_{n} = {a}_{n} - {b}_{n} = {a}_{n} - {\sum }_{l = 1}^{B} {c}_{l} {d}_{( n - l ) mod N} , \qquad ( 6 )$$

where cₗ is an N_{T}-by-N_{T} square matrix representing the coefficients of the NPs 240 at an l-th tap, and:

dₙ₋ₗ=aₙ₋ₗ−\hat{x}ₙ₋ₗ. (7)

It should be appreciated that as used in Equation (7) and generally herein, the notation “modN” may be omitted from the subscript of the expressions d_{(n-l)modN}, a_{(n-l)modN}, and x_{(n-l)modN} for brevity. The detection error of the NPs 240 may then be given by the following equation:

$$\begin{matrix}{ɛ}_{n} = {z}_{n} - {x}_{n} = {d}_{n} - {\sum }_{l = 1}^{B} {c}_{l} {d}_{n - l} = {\sum }_{l = 0}^{B} {g}_{l} {d}_{n - l} , where & ( 8 ) \\ {g}_{l} = \{ \begin{matrix}{I}_{{N}_{T}} & l = 0 \\ - {c}_{l} & l = 1 , … , B\end{matrix} . & ( 9 )\end{matrix}$$

The auto-correlation matrix of εₙ may then be expressed as follows:

$$E \{ {ɛ}_{n} {ɛ}_{n}^{H} \} = {\sum }_{{l}_{1} = 0}^{B} {\sum }_{{l}_{2} = 0}^{B} {g}_{{l}_{1}} E \{ {d}_{n - {l}_{1}} {d}_{n - {l}_{2}}^{H} \} {g}_{{l}_{2}}^{H} . \qquad ( 10 )$$

Based on the auto-correlation matrix of εₙ given by Equation (10), the MSE of the NPs 240 may then be equivalent to the trace of Equation (10).

In a specific, non-limiting example, the coefficients of the feedforward FDE 220 can then be determined as follows. First, an assumption may be made for simplicity of equalizer design and determination of equalizer coefficients that the feedback symbols given by the NPs 240 are always correct, i.e., \hat{x}ₙ₋ₗ=xₙ₋ₗ. Based on this assumption and by substituting Equation (5) into Equation (7), dₙ₋ₗ may be equivalent to the following:

$$\begin{matrix}\begin{matrix}{d}_{n - l} = {a}_{n - l} - {x}_{n - l} \\ = \frac{1}{\sqrt{N}} {\sum }_{k = 0}^{N - 1} {W}_{k} {H}_{k} {X}_{k} {e}^{j \frac{2 π}{N} k ( n - l )} + \\ \frac{1}{\sqrt{N}} {\sum }_{k = 0}^{N - 1} {W}_{k} {V}_{k} {e}^{j \frac{2 π}{N} k ( n - l )} - {x}_{n - l} .\end{matrix} & ( 11 )\end{matrix}$$

From Equation (11), the following may then be proven:

$$E \{ {d}_{n - {l}_{1}} {d}_{n - {l}_{2}}^{H} \} = \frac{1}{N} {\sum }_{k = 0}^{N - 1} {e}^{j \frac{2 π}{N} ( {l}_{2} - {l}_{1} ) k} [ {σ}_{x}^{2} ( {W}_{k} {H}_{k} {H}_{k}^{H} {W}_{k}^{H} - {W}_{k} {H}_{k} - {H}_{k}^{H} {W}_{k}^{H} ) + {σ}_{v}^{2} {W}_{k} {W}_{k}^{H} ] + {σ}_{x}^{2} {I}_{{N}_{T}} δ ( {l}_{2} - {l}_{1} ) . \qquad ( 12 )$$

By substituting Equation (12) into Equation (10) and differentiating the trace of Equation (10) with respect to Wₖ and setting the result to zero, the following may then be obtained:

$$\begin{matrix}\begin{matrix}\frac{\partial tr \{ E \{ {ɛ}_{n} {ɛ}_{n}^{H} \} \}}{\partial {W}_{k}} = \frac{1}{N} {\sum }_{{l}_{1} = 0}^{B} {\sum }_{{l}_{2} = 0}^{B} \\ \{ {e}^{- j \frac{2 π}{N} ( {l}_{2} - {l}_{1} ) k} {g}_{{l}_{1}}^{H} {g}_{{l}_{2}} \{ {σ}_{x}^{2} {W}_{k} {H}_{k} {H}_{k}^{H} + {σ}_{v}^{2} {W}_{k} - {σ}_{x}^{2} {H}_{k}^{H} \} \} + \\ \frac{1}{N} {\sum }_{{l}_{1} = 0}^{B} {\sum }_{{l}_{2} = 0}^{B} \\ \{ {e}^{j \frac{2 π}{N} ( {l}_{2} - {l}_{1} ) k} {g}_{{l}_{2}}^{H} {g}_{{l}_{1}} \{ {σ}_{x}^{2} {W}_{k} {H}_{k} {H}_{k}^{H} + {σ}_{v}^{2} {W}_{k} - {σ}_{x}^{2} {H}_{k}^{H} \} \} \\ = 0 ,\end{matrix} & ( 13 )\end{matrix}$$

and from Equation (13), the coefficients of the feedforward FDE 220 may then be determined as follows:

Wₖ=σₓ²Hₖ^{H}[σₓ²HₖHₖ^{H}+σᵥ²I_{N}_{_{R}}]⁻¹. (14)

In an additional specific, non-limiting example, the coefficients of the NPs 240 can be determined as follows. First, Equation (14) can be substituted into Equation (12). From this substitution, the following equation may be derived:

$$E \{ {d}_{n - {l}_{1}} {d}_{n - {l}_{2}}^{H} \} = \frac{{σ}_{x}^{2} {σ}_{v}^{2}}{N} {\sum }_{k = 0}^{N - 1} {e}^{j \frac{2 π}{N} ( {l}_{2} - {l}_{1} ) k} {Γ}_{k}^{- 1} , \qquad ( 15 )$$

where Γₖ=[σₓ²Hₖ^{H}Hₖ+σᵥ²I_{N}_{_{T}}]. Equation (15) may then be substituted into Equation (10) to obtain the following:

$$E \{ {ɛ}_{n} {ɛ}_{n}^{H} \} = \frac{{σ}_{x}^{2} {σ}_{v}^{2}}{N} {\sum }_{{l}_{1} = 0}^{B} {\sum }_{{l}_{2} = 0}^{B} {g}_{{l}_{1}} {\sum }_{k = 0}^{N - 1} {e}^{- j \frac{2 π}{N} {l}_{1} k} {Γ}_{k}^{- 1} {e}^{j \frac{2 π}{N} {l}_{2} k} {g}_{{l}_{2}}^{H} . \qquad ( 16 )$$

The trace of Equation (16) may then be differentiated with respect to cₗ. By setting the result of the differentiation to zero, the following equation may be obtained:

$${\sum }_{k = 0}^{N - 1} {Γ}_{k}^{- 1} {e}^{j \frac{2 π}{N} lk} = {\sum }_{m = 1}^{B} {\sum }_{k = 0}^{N - 1} {c}_{l} {Γ}_{k}^{- 1} {e}^{- j \frac{2 π}{N} ( m - l ) k} \\ l = 1 , … , B . \qquad ( 17 )$$

Finally, Equation (17) can be re-written in the following form:

$$[ \begin{matrix}{q}_{1}^{H} \\ {q}_{2}^{H} \\ ⋮ \\ {q}_{B}^{H}\end{matrix} ] = [ \begin{matrix}{q}_{0} & {q}_{1} & ⋯ & {q}_{B - 1} \\ {q}_{1}^{H} & {q}_{0} & & {q}_{B - 2} \\ ⋮ & ⋮ & ⋰ & ⋮ \\ {q}_{B - 1}^{H} & {q}_{B - 2}^{H} & ⋯ & {q}_{0}\end{matrix} ] [ \begin{matrix}{c}_{1}^{H} \\ {c}_{2}^{H} \\ ⋮ \\ {c}_{B}^{H}\end{matrix} ] , \qquad ( 18 )$$

where

$${q}_{l} = {\sum }_{k = 0}^{N - 1} {Γ}_{k}^{- 1}$$

exp(j2πlk/N) and the solution of (18) represents the coefficients of the NPs 240.

In accordance with one aspect of the present invention, the MMSE of the FDE-NP scheme utilized by receiver structure 200 can be determined by substituting Equations (9) and (18) into Equation (16) as follows:

$${MMSE}_{FDE \text{-} NP} = tr \{ E \{ {ɛ}_{n} {ɛ}_{n}^{H} \} \} = \frac{{σ}_{x}^{2} {σ}_{v}^{2}}{N} tr \{ {q}_{0} - {\sum }_{l = 1}^{B} {c}_{l} {q}_{l}^{H} \} . \qquad ( 19 )$$

In one example, by comparing the results derived in the above equations for the FDE-NP scheme utilized by receiver structure 200 and the results of a conventional FD-DFE scheme, it can be proven that the coefficients of the NPs 240 given in Equation (18) have substantially the same magnitude as the coefficients of the feedback filters of the conventional FD-DFE scheme as follows. First, the coefficients of the feedback filters utilized in a conventional FD-DFE scheme are traditionally determined by satisfying the following equation:

$${\sum }_{k = 0}^{N - 1} {T}_{k}^{H} {Γ}_{k}^{- 1} = - {\sum }_{k = 0}^{N - 1} {T}_{k}^{H} {Γ}_{k}^{- 1} {T}_{k} f , \qquad ( 20 )$$

where Γₖ=σₓ²Hₖ^{H}Hₖ+σᵥ²I_{N}_{_{T}}] and the feedback coefficients are contained in the matrix f^{H} having N_{T}×(N_{T}·B) entries. Additionally, as used in Equation (20), Tₖ is a N_{T}×(N_{T}·B) matrix that can be given by the following:

$${T}_{k} = [ \begin{matrix}{e}^{j \frac{2 π}{N} k \cdot 1} ⋯ {e}^{j \frac{2 π}{N} k \cdot B} & {0}_{1 \times B} & ⋯ & {0}_{1 \times B} \\ {0}_{1 \times B} & {e}^{j \frac{2 π}{N} k \cdot 1} … {e}^{j \frac{2 π}{N} k \cdot B} & ⋯ & {0}_{1 \times B} \\ ⋮ & ⋮ & ⋰ & ⋮ \\ {0}_{1 \times B} & {0}_{1 \times B} & ⋯ & {e}^{j \frac{2 π}{N} k \cdot 1} … {e}^{j \frac{2 π}{N} k \cdot B}\end{matrix} ] . \qquad ( 21 )$$

A permutation matrix Ω can then be found for Tₖ such that:

$${T}_{k} Ω = [ \begin{matrix}{e}^{j \frac{2 π}{N} k \cdot 1} {I}_{{N}_{T}} & {e}^{j \frac{2 π}{N} k \cdot 2} {I}_{{N}_{T}} & ⋯ & {e}^{j \frac{2 π}{N} k \cdot B}\end{matrix} {I}_{{N}_{T}} ] . \qquad ( 22 )$$

Next, by multiplying Ω^{H} to both sides of Equation (20), the following may be obtained:

$${\sum }_{k = 0}^{N - 1} {[ \begin{matrix}{e}^{j \frac{2 π}{N} k \cdot 1} {I}_{{N}_{T}} & ⋯ & {e}^{j \frac{2 π}{N} k \cdot B} {I}_{{N}_{T}}\end{matrix} ]}^{H} {Γ}_{k}^{- 1} = - {\sum }_{k = 0}^{N - 1} {Ω}^{H} {T}_{k}^{H} {Γ}_{k}^{- 1} {T}_{k} f . \qquad ( 23 )$$

It should be appreciated from Equation (23) that the left side of Equation (23) is equal to the left side of Equation (18). In addition, it should be appreciated that Ω is a unitary matrix. Accordingly, the following property holds for Ω:

Ω⁻¹=Ω^{H}=Ω^{T}. (24)

The following equation can then be derived by using the property expressed in Equation (24) in the right hand side of Equation (23):

$$- {\sum }_{k = 0}^{N - 1} {Ω}^{H} {T}_{k}^{H} {Γ}_{k}^{- 1} {T}_{k} f = - ( {\sum }_{k = 0}^{N - 1} {Ω}^{H} {T}_{k}^{H} {Γ}_{k}^{- 1} {T}_{k} Ω ) {Ω}^{H} f . \qquad ( 25 )$$

It should be appreciated that the term in parentheses in the right side of Equation (25) is equal to the matrix in Equation (18). Thus, by considering Equations (18), (23), and (25) together, the following may be derived:

Ω^{H}f=−[c₁ c₂ . . . c_{B}]^{H}, (26)

where the entries of each element cᵢ can be expressed as:

c_{i,jk}=−(fₗₖ)* for j,k=1, . . . , N_{T}, (27)

where l=(j−1)×B+i.

By then comparing the coefficients of the feedforward FDE utilized in the conventional FD-DFE MIMO scheme and the coefficients of the feedforward FDE in the FDE-NP scheme employed by receiver structure 200, it can be found that the coefficients of said schemes have the following relationship. In a conventional FD-DFE scheme, the coefficients of the feedforward FDE are given as follows:

Ŵₖ=σₓ²(I_{N}_{_{T}}+f^{H}Tₖ^{H})Hₖ^{H}(σₓ²HₖHₖ^{H}+σᵥ²I_{N}_{_{R}})⁻¹. (28)

By then multiplying Equation (22) to Equation (26) and using the property expressed in Equation (24), the following may be derived:

$${T}_{k} f = {T}_{k} {ΩΩ}^{H} f = - {\sum }_{l = 1}^{B} {c}_{l}^{H} {e}^{j \frac{2 π}{N} k} . \qquad ( 29 )$$

The following expression for Ŵₖ can then be obtained by substituting Equations (29) and (14) into Equation (28):

$${\hat{W}}_{k} = ( {I}_{{N}_{T}} - {\sum }_{l = 1}^{B} {c}_{l} {e}^{- j \frac{2 π}{N} kl} ) {W}_{k} . \qquad ( 30 )$$

Similarly, the following expression for Ŵₖ can be derived for the FDE-NP scheme utilized by receiver structure 200:

$${\hat{W}}_{k} = {\sum }_{l = 0}^{B} {g}_{l} {W}_{k} {e}^{- j \frac{2 π}{N} kl} . \qquad ( 31 )$$

Equation (31) shows the relationship between the coefficients of the feedforward FDE in the conventional FD-DFE scheme and the coefficients of the feedforward FDE 220 in the FDE-NP scheme utilized by receiver structure 200. From this equation, it can also be seen that the equalized signals generated by the FD-DFE MIMO scheme are similar to those generated by receiver structure 200.

Additionally, it can be proven that the conventional FD-DFE scheme and the FDE-NP scheme utilized by receiver structure 200 also have the same MMSE as follows. First, the autocorrelation matrix of the error vector in the conventional FD-DFE scheme can be expressed as follows:

$$E \{ {ɛ}_{n} {ɛ}_{n}^{H} \} = \frac{{σ}_{x}^{2} {σ}_{v}^{2}}{N} {\sum }_{k = 0}^{N - 1} ( {I}_{{N}_{T}} + {f}^{H} {T}_{k}^{H} ) {{Γ}_{k}^{- 1} ( {I}_{{N}_{T}} + {f}^{H} {T}_{k}^{H} )}^{H} . \qquad ( 32 )$$

By then substituting Equation (29) into Equation (32), the following may be obtained:

$$E \{ {ɛ}_{n} {ɛ}_{n}^{H} \} = \frac{{σ}_{x}^{2} {σ}_{v}^{2}}{N} {\sum }_{k = 0}^{N - 1} ( {I}_{{N}_{T}} - {\sum }_{{l}_{1} = 1}^{B} {c}_{{l}_{1}} {e}^{- j \frac{2 π}{N} {kl}_{1}} ) {{Γ}_{k}^{- 1} ( {I}_{{N}_{T}} - {\sum }_{{l}_{2} = 1}^{B} {c}_{{l}_{2}} {e}^{- j \frac{2 π}{N} {kl}_{2}} )}^{H} . \qquad ( 33 )$$

The definition of gₗ expressed by Equation (9) may then be substituted into Equation (33) to obtain the following:

$$E \{ {ɛ}_{n} {ɛ}_{n}^{H} \} = \frac{{σ}_{x}^{2} {σ}_{v}^{2}}{N} {\sum }_{k = 0}^{N - 1} {\sum }_{{l}_{1} = 0}^{B} {\sum }_{{l}_{2} = 1}^{B} {g}_{{l}_{1}} {e}^{j \frac{2 π}{N} k ( {l}_{2} - {l}_{1} )} {Γ}_{k}^{- 1} {g}_{{l}_{2}}^{H} . \qquad ( 34 )$$

It should be appreciated that Equation (34) is substantially similar to Equation (16). Thus, the MMSE of the conventional FD-DFE scheme, which is the trace of Equation (34), is the same as that of the FDE-NP scheme utilized by the receiver structure 200.

In light of the comparisons between the conventional FD-DFE scheme and the FDE-NP scheme utilized by receiver structure 200 made in Equations (30)-(34) above, it should be appreciated that receiver structure 200 can be an optimal design in the MMSE sense in a similar manner to the conventional FD-DFE scheme. However, unlike the conventional FD-DFE scheme, it should be appreciated from Equation (14) that the coefficients of the feedforward FDE 220 in the FDE-NP scheme utilized by receiver structure 200 are independent of the order B of the NPs 240. Instead, it should be appreciated that the coefficients of the feedforward FDE 220 are substantially similar to the coefficients of the conventional FD-LE scheme. As a result, only the NPs 240 may be affected if the number of feedback taps utilized by receiver structure 200 needs to be changed. This is in contrast to the conventional FD-DFE scheme, where both the feedforward FDE and the feedback time domain filters must be changed in such a case. Accordingly, performance/complexity trade-offs may be easier to achieve with receiver structure 200 than with traditional equalization schemes. Further, the FDE-NP scheme utilized by receiver structure 200 may be more flexible and adaptive to practical systems than traditional equalization schemes. In addition, unlike conventional equalization schemes, the FDE-NP scheme utilized by receiver structure 200 can take advantage of the MIMO architecture to reliably detect different data streams while guaranteeing individual quality of service (QoS) requirements for each stream through the use of different orders for different NPs 240. This can be accomplished with receiver structure 200 by dynamically changing the structure of one or more NPs 240 without affecting the feedforward FDE 220.

In accordance with one aspect of the present invention, the FDE-NP scheme utilized by receiver structure 200 can be combined with other methods of channel equalization in MIMO systems. For example, receiver structure 200 can be extended into a layered space-frequency architecture where group detection can be implemented. This process may be performed in successive stages where the detected streams, which are considered as a virtual group, are canceled out from the received signal at a given stage according to their detection order. Since the feedforward FDE 220 is independent of the structure of the NPs 240, receiver structure 200 can be flexibly designed to implement this equalization method and/or other suitable equalization methods.

Referring now to FIG. 2B, a block diagram of an exemplary feedback noise predictor 240₁ in accordance with an aspect of the present invention is illustrated. In one example, equalized data a_{n,p} corresponding to a p-th data stream at a given time n can be received by the feedback noise predictor 240₁. The feedback noise predictor 240₁ may also include a detector 241 that can detect \hat{x}_{n,p} based on a value of z_{n,p}, which is obtained by subtracting equalized data a_{n,p} from predicted noise b_{n,p} at an adder 247₁. The feedback noise predictor may also include a noise predictor component 242, which can determine the predicted noise b_{n,p} based on a distortion d_{n,p} for the p-th data stream at time n, which may be determined by subtracting detected data \hat{x}_{n,p} from equalized data a_{n,p} at an adder 247₂, and previous distortions d_{n,i} for all data streams i where i≠p.

Turning to FIG. 2C, a block diagram of an alternative exemplary feedback noise predictor 240₂ in accordance with an aspect of the present invention is illustrated. In one example of the present invention, feedback noise predictor 240₁ in FIG. 2B can be utilized in a MIMO system without channel coding while feedback noise predictor 240₂ in FIG. 2C can be utilized in MIMO systems with channel coding. In one example, the MIMO system may utilize an interleaver and a deinterleaver 243 to rearrange the order of symbol sequences so that reliable post-decoding decisions can be fed back to effectively cancel part of the remaining interference. Further, a simple block interleaving structure can be implemented in a MIMO system (e.g., a system 100) in conjunction with the FDE-NP scheme utilized by feedback noise predictor 240₂. Specifically, a transmitter (e.g., a transmitter 10) may reorder blocks from each data stream to be transmitted using a similar block interleaving scheme, wherein the coded symbols are written in a rectangular interleaving block column-by-column and read out row-by-row. A receiver (e.g., a receiver 20 at which feedback noise predictor 240₂ is implemented) may then equalize the streams, and each equalized stream at the receiver may then be written row-by-row into the same rectangular block and read out column-by-column by deinterleaver 243. Thus, it can be seen that two adjacent linearly equalized symbols in the same row will be separated after deinterleaving by a fixed distance equal to the column length of the interleaving block. The column length is represented in the feedback noise predictor 240₂ as a delay component 244. If the delay of a decoder 245 at the feedback noise predictor 240₂ (e.g. the trace back window for a Viterbi decoder) is less than the column length, then post-decoding decisions, which may have more reliability than the instantaneous hard decisions prior to the decoder 245, can be passed through a symbol generator 246 and fed back to a noise predictor component 242 to cancel part of the post-cursor interferences of the preceding symbols in the same row. In a MIMO system such as system 100 and in contrast to a SISO system, the noise predictor component 242 can receive the post-decoding decisions of a particular stream p as well as those of other streams. These decisions can then be used by the noise predictor component 242 to effectively cancel part of the remaining ISI and CCI effectively.

In one example, there may not be enough decided information from the decoder 245 and symbol generator 246 for performing ISI cancellation on the signals in the first several columns of the interleaving block. In this case, signals in earlier columns may only be linearly equalized. Alternatively, since the order of feedback noise predictors 240₂ can be varied without affecting the feedforward FDE (e.g., the feedforward FDE 220), the feedback noise predictors 240₂ can be designed adaptively depending on how many post-decoding decisions have been provided by the decoder 245. In another alternative, the order of the feedback noise predictors 240₂ may be fixed and training symbols may be inserted in the first several columns of the interleaving block for initialization. However, as training symbols may affect the spectral and power efficiencies of the system, the number of training symbols that are inserted should be carefully decided.

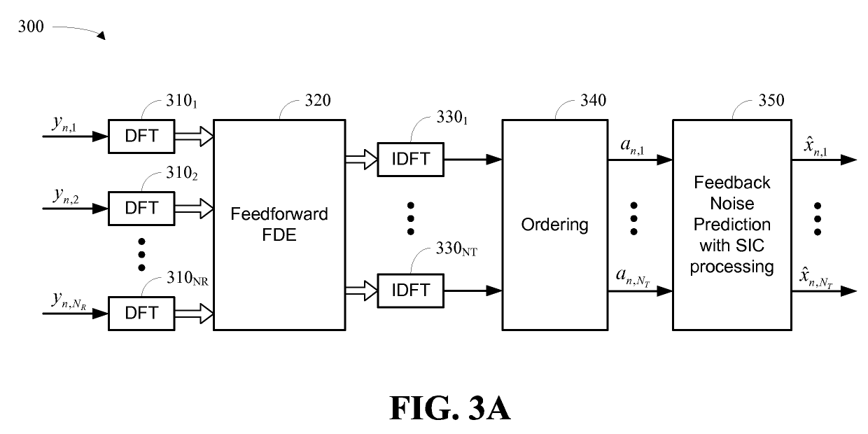

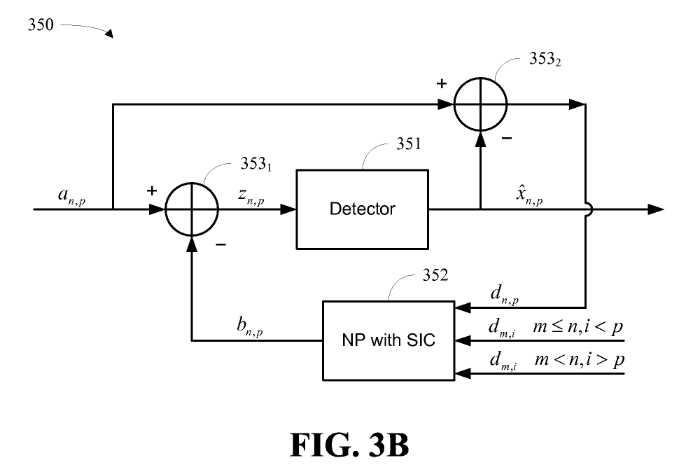

Referring to FIG. 3A, a block diagram of an exemplary receiver structure 300 in accordance with an aspect of the present invention is illustrated. By way of non-limiting example, receiver structure 300 may be implemented as an equalization component (e.g., an equalization component 24) at a receiver (e.g. a receiver 20). In one example of the present invention, receiver structure 300 is operable to perform channel equalization on received signals from respective receive antennas (e.g., signals received from receive antennas 22 at a receiver 20) based on an FDE-NP-SIC scheme. By way of non-limiting example, an FDE-NP-SIC scheme may be implemented by receiver structure 300 as follows. First, an input vector yₙ corresponding to time domain signals received at N_{R} receive antennas (e.g., receive antennas 22) can be converted to the frequency domain by using a DFT operation at blocks 310. Feedforward equalization may then be performed in the frequency domain by a frequency domain equalizer (FDE) 320 at a k-th frequency tone in a similar manner to FDE 220. The resulting vector Aₖ may then also be converted back to the time domain by using an IDFT operation at blocks 330 in a similar manner to receiver structure 200.

In another example of the present invention, receiver structure 300 further includes an ordering component 340 that orders each data stream in the time domain vector aₙ according to their MMSEs. The ordered data streams in aₙ may then be passed to feedback NPs 350, wherein the streams can be detected in increasing order by their MMSEs. By detecting the streams in increasing order according to their MMSEs, the NPs 350 can consider previous decisions of all the data streams as well as current decisions of lower-index streams for distortion prediction.

In accordance with one aspect of the present invention, the components of receiver structure 300 may perform channel equalization according to an FDE-NP-SIC scheme as follows. First, the FDE may operate in a similar manner to receiver structure 200 by using Equation (2). In addition, the data streams in Xₖ as used in Equation (2) may be ordered increasingly by their MMSEs. Thus, the equalized signals from the FDE 320 may be expressed as follows:

$${z}_{n} = {a}_{n} - {b}_{n} = {a}_{n} - {\sum }_{l = 0}^{B} {c}_{l} {d}_{n - l} , \qquad ( 35 )$$

where c₀ is a lower triangular matrix with the elements along its diagonal equal to zero. The detection error vector εₙ may then be expressed using Equation (10), where gₗ is defined as follows:

$${g}_{l} \{ \begin{matrix} {I}_{{N}_{T}} - {c}_{l} & l = 0 \\ - {c}_{l} & l = 1 , … , B\end{matrix} . \qquad ( 36 )$$

It follows from Equation (36) that the FDE-NP scheme utilized by receiver structure 200 may be viewed as a special case of the FDE-NP-SIC scheme utilized by receiver structure 300 when c₀=0_{N}_{_{T}}^{×N}_{_{T}}. Following the same derivation procedure utilized for receiver structure 200 given by Equations (8)-(14), it also follows that the optimal coefficients of the feedforward FDE 320 in the FDE-NP-SIC scheme utilized by receiver structure 300 are substantially identical to the coefficients given in Equation (14), which in turn are substantially identical to the coefficients utilized by the conventional FD-LE scheme. Additionally, it should be appreciated that the resulting autocorrelation matrix of the error vector for the FDE-NP-SIC scheme utilized by receiver structure 300 can be expressed by using Equation (16), with the exception that gₗ is defined for receiver structure 300 by Equation (36). Accordingly, Equation (16) can be rewritten for receiver structure 300 in a concise form as follows:

$$E \{ {ɛ}_{n} {ɛ}_{n}^{H} \} = \frac{{σ}_{x}^{2} {σ}_{v}^{2}}{N} {gQg}^{H} , \qquad ( 37 )$$

where g=[g₀ g₁ . . . g_{B}] and Q is a block matrix with block entries

$${Q}_{mn} = {\sum }_{k = 0}^{N - 1} {Γ}_{k}^{- 1} exp ( j2π ( n - m ) k / N ) for m , n = 1 , … , B + 1.$$

Based on the coefficients determined for the FDE 320, the optimal coefficients for the NPs 350 can be obtained by solving the following constraint optimization problem:

$${min}_{g} tr \{ E \{ {ɛ}_{n} {ɛ}_{n}^{H} \} \} = {min}_{g} tr \{ \frac{{σ}_{x}^{2} {σ}_{v}^{2}}{N} {gQg}^{H} \} \qquad ( 38 )$$

subject to

gΨ=g₀, (39)

where Ψ=[I_{N}_{_{T}} 0_{N}_{_{T}}_{×(N}_{_{T}}_{B)}]^{H}. By applying the Lagrange optimization method, the optimal g can then be determined as follows:

gₒₚₜ=g₀(Ψ^{H}Q⁻¹Ψ)⁻¹Ψ^{H}Q⁻¹. (40)

Based on Equation (40), Q and Q⁻¹ can be respectively defined as

$$Q = [ \begin{matrix}{Q}_{11} & {Q}_{12} \\ {Q}_{12}^{H} & {Q}_{22}\end{matrix} ]$$

and

$${Q}^{- 1} [ \begin{matrix}{R}_{11} & {R}_{12} \\ {R}_{12}^{H} & {R}_{22}\end{matrix} ] ,$$

where R₁₁ and Q₁₁ are N_{T}-by-N_{T} matrices and R₂₂ and Q₂₂ are N_{T}B-by-N_{T}B matrices, respectively. Based on these definitions, Equation (40) can be rewritten as follows:

gₒₚₜ=[g₀−g₀Q₁₂Q₂₂⁻¹]. (41)

By substituting Equation (41) into Equation (38), the optimization problem in (38) can be expressed as the following:

$${min}_{g} tr [ E \{ {ɛ}_{n} {ɛ}_{n}^{H} \} \} = {min}_{g} tr \{ \frac{{σ}_{x}^{2} {σ}_{v}^{2}}{N} {gQg}^{H} \} = {min}_{{g}_{0}} tr \{ \frac{{σ}_{x}^{2} {σ}_{v}^{2}}{N} {g}_{0} {R}_{11}^{- 1} {g}_{0}^{H} \} . \qquad ( 42 )$$

From Equation (42), it then follows that the optimal g₀ which satisfies Equation (42) is L⁻¹, where L is the lower triangular matrix in the Cholesky factorization of R₁₁⁻¹=LDL^{H}. Finally, by considering the optimal g₀ in Equations (36) and (42) together, the coefficients of the NPs 350 can be determined by using the following equation:

[c₀ c₁ . . . c_{B}]=[I−L⁻¹ L⁻¹Q₁₂Q₂₂⁻¹]. (43)

In accordance with one aspect, the resulting MMSE of the FDE-NP-SIC scheme utilized by receiver structure 300 can be expressed as follows:

$${MMSE}_{FDE - NP - SIC} = tr \{ \frac{{σ}_{x}^{2} {σ}_{v}^{2}}{N} D \} = \frac{{σ}_{x}^{2} {σ}_{v}^{2}}{N} {\sum }_{i = 1}^{{N}_{T}} {D}_{ii} . \qquad ( 44 )$$

In one example, since the coefficients of the feedforward FDE 320 in receiver structure 300 are the same as the coefficients utilized in FD-LE, the equalized streams from the feedforward FDE 320 can be ordered by the ordering component 340 according to MMSE_{LE}. In addition, it should be appreciated that the conventional FD-LE scheme can be viewed as a special case of the FDE-NP scheme utilized by receiver structure 200 wherein the order B of the NPs 240 is zero. Thus, by setting B to zero in Equation (16), MMSE_{LE} can be obtained from the following error autocorrelation matrix:

$$E \{ {ɛ}_{n} {ɛ}_{n}^{H} \} = \frac{{σ}_{x}^{2} {σ}_{v}^{2}}{N} {\sum }_{k = 0}^{N - 1} {Γ}_{k}^{- 1} , \qquad ( 45 )$$

where the MMSEs of the linearly equalized streams are the diagonal elements in Equation (45).

In accordance with one aspect of the present invention, the FDE-NP-SIC scheme utilized by receiver structure 300 can be combined with other methods of channel equalization in MIMO systems. For example, receiver structure 300 can be extended into a layered space-frequency architecture where group detection can be implemented. This process may be performed in successive stages where the detected streams, which are considered as a virtual group, are canceled out from the received signal at a given stage according to their detection order. Since the feedforward FDE 320 is independent of the structure of the NPs 350, receiver structure 200 can be flexibly designed to implement this equalization method and/or other suitable equalization methods.

Turning to FIG. 3B, a block diagram of an exemplary feedback noise predictor 350 in accordance with an aspect of the present invention is illustrated. In one example, equalized data a_{n,p} corresponding to ap-th data stream at a given time n can be received by the feedback noise predictor 350. In another example, the feedback noise predictor 350 may include a detector 351 that can detect \hat{x}_{n,p} based on a value of z_{n,p}, which is obtained by subtracting equalized data a_{n,p} from predicted noise b_{n,p} at an adder 353₁. The feedback noise predictor may also include a noise predictor component 352 that can utilize successive interference cancellation (SIC) to determine the predicted noise b_{n,p} based on a distortion d_{n,p} for the p-th data stream at time n, which may be determined by subtracting detected data \hat{x}_{n,p} from equalized data an a_{n,p} at an adder 353₂, previous distortions d_{m,i} for all data streams having an index i where i≠p, and current distortions d_{n,i} for data streams having an index i where i<p.

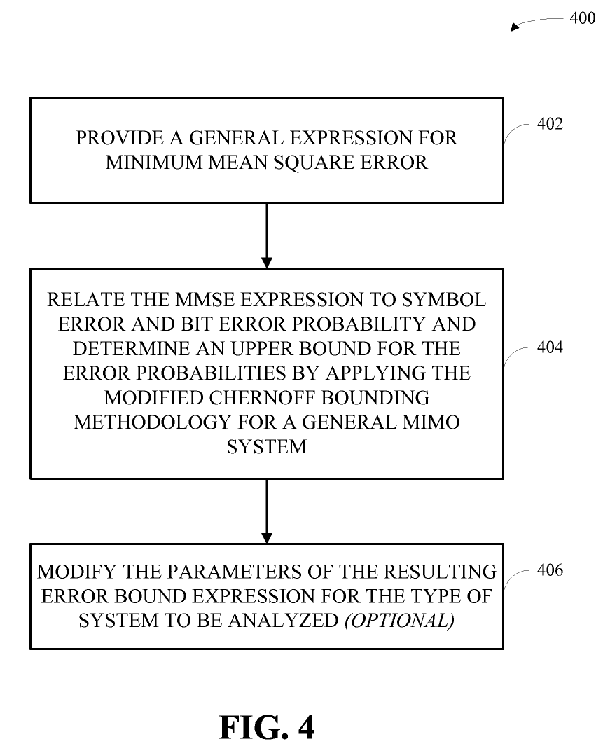

Referring now to FIG. 4, a method 400 for analyzing the performance of a MIMO system with equalization (e.g., a MIMO system 100) in accordance with an aspect of the present invention is illustrated. While, for purposes of simplicity of explanation, method 400 is shown and described as a series of blocks, it is to be understood and appreciated that method 400 is not limited by the order of the blocks, as some blocks may, in accordance with the present invention, occur in different orders and/or concurrently with other blocks from that shown and described herein. Moreover, not all illustrated blocks may be required to implement method 400 in accordance with the present invention.

In one example of the present invention, method 400 begins at 402 by providing a general expression for MMSE that may be utilized by, for example, the conventional FD-LE and FD-DFE schemes as well as the FDE-NP scheme utilized by receiver structure 200 and the FDE-NP-SIC scheme utilized by receiver structure 300. By way of non-limiting example, the MMSE expression may be provided in accordance with the following. First, by substituting Equation (5) into Equation (35), the equalized signals produced by the FDE-NP-SIC structure 300 can be expressed as follows:

$$\begin{matrix}{z}_{n} = \frac{1}{\sqrt{N}} {\sum }_{k = 0}^{N - 1} {\hat{W}}_{k} {H}_{k} {X}_{k} {e}^{j \frac{2 π}{N} kn} + {\sum }_{l = 0}^{B} {c}_{l} {x}_{n - l} + \frac{1}{\sqrt{N}} {\sum }_{k = 0}^{N - 1} {\hat{W}}_{k} {V}_{k} {e}^{j \frac{2 π}{N} kn} , \\ where & ( 46 ) \\ {\hat{W}}_{k} = {\sum }_{l = 0}^{B} {g}_{l} {W}_{k} {e}^{- j \frac{2 π}{N} kl} . & ( 47 )\end{matrix}$$

In accordance with one aspect of the present invention, the FDE-NP scheme utilized by receiver structure 200 is a special case of the FDE-NP-SIC scheme utilized by receiver structure 300 when c₀=0_{N}_{_{T}}_{×N}_{_{T}}. By using Equations (20)-(31) as described above, it can then be shown that Ŵₖ is substantially the same feedforward FDE coefficient for a k-th frequency tone as the corresponding coefficient of the conventional FD-DFE scheme. Further, it can be shown by using the same equations that the equalized data zₙ are substantially identical in both the FD-DFE and FDE-NP schemes. Equation (46) can then be rewritten in the form of time domain convolution as follows:

$${z}_{n} = {\sum }_{m = 0}^{N - 1} {f}_{m} {x}_{n - m} + {\sum }_{l = 0}^{B} {c}_{l} {x}_{n - l} + {u}_{n} , \\ where \\ {f}_{m} = ( 1 / N ) {\sum }_{k = 0}^{N - 1} {\hat{W}}_{k} {H}_{k} {e}^{j2π km / N} \\ and \\ {u}_{n} = ( 1 / N ) {\sum }_{k = 0}^{N - 1} {\hat{W}}_{k} {V}_{k} {e}^{j 2 π kn / N} . \qquad ( 48 )$$

Based on Equation (48), it can then be established that the MMSE of the conventional FD-LE and FD-DFE schemes, the FDE-NP scheme utilized by receiver structure 200, and the FDE-NP-SIC scheme utilized by receiver structure 300 can generally be given by:

$$MMSE = tr \{ E \{ {ɛ}_{n} {ɛ}_{n}^{H} \} \} = {σ}_{x}^{2} {\sum }_{p = 1}^{{N}_{T}} ( 1 - {f}_{0 , pp} ) , \qquad ( 49 )$$

where f_{i,jk} is the jk-th entry of the matrix fᵢ. This may be established, for example, as follows. As noted above, the conventional FD-LE scheme can be seen as a special case of the FD-DFE and FDE-NP schemes when the number of feedback taps is equal to zero. As further noted above, the FD-DFE and the FDE-NP schemes produce substantially the same equalized data. In addition, the FDE-NP scheme can also be seen as a special case of the FDE-NP-SIC scheme. Thus, the error vector corresponding to Equation (49) can be written as follows:

$$\begin{matrix}\begin{matrix}{ɛ}_{n} = {z}_{n} - {x}_{n} \\ = ( {f}_{0} + {c}_{0} - {I}_{{N}_{T}} ) {x}_{n} + {\sum }_{m = 1}^{B} ( {f}_{m} + {c}_{m} ) {x}_{n - l} + \\ {\sum }_{m = B + 1}^{N - 1} {f}_{m} {x}_{n - m} + {u}_{n} .\end{matrix} & ( 50 )\end{matrix}$$

The MSE corresponding to Equation (49) is the trace of the autocorrelation matrix of εₙ, which can be determined as follows. Based on the MMSE criterion, it can be shown that

Lt(f₀)=−Lt(c₀) (51)

and

fₘ=−cₘ m=1, . . . , B, (52)

where Lt(A) represents the elements below the diagonal of a matrix A. By considering Equations (50)-(52) together, the autocorrelation matrix of the error vector εₙ can then be expressed as follows:

$$E \{ {ɛ}_{n} {ɛ}_{n}^{H} \} = {σ}_{x}^{2} ( ( {f}_{0} + {c}_{0} - {I}_{{N}_{T}} ) {( {f}_{0} + {c}_{0} - {I}_{{N}_{T}} )}^{H} + {\sum }_{m = B + 1}^{N - 1} {f}_{m} {f}_{m}^{H} ) + E \{ {u}_{n} {u}_{n}^{H} \} . \qquad ( 53 )$$

Next, W and Gₘ can be defined such that W=[Ŵ₀ . . . Ŵ_{N-1}]^{T} and

$${G}_{m} = {\frac{1}{N} [ {H}_{0}^{T} {e}^{j \frac{2 π}{N} m 0} … {H}_{N - 1}^{T} {e}^{j \frac{2 π}{N} m ( N - 1 )} ]}^{T}$$

such that fₘ=W^{T}Gₘ. From these definitions, it follows that:

$$E \{ {u}_{n} {u}_{n}^{H} \} = \frac{{σ}_{v}^{2}}{N} {W}^{T} {W}^{*} . \qquad ( 54 )$$

Based on Equation (54), Equation (53) can be rewritten as follows:

E{εₙεₙ^{H}}=W^{T}ΦW*−σₓ²{W^{T}G₀[c₀^{H}−I_{N}_{_{T}}]+[c₀−I_{N}_{_{T}}]G₀^{H}W*+[c₀−I_{N}_{_{T}}][c₀^{H}−I_{N}_{_{T}}]}, (55)

where

$$Φ = ( {\sum }_{m ∈ S} {σ}_{x}^{2} {G}_{m} {G}_{m}^{H} + {σ}_{v}^{2} {I}_{{N}_{R} N} / N )$$

and S={0}∪{B+1, . . . , N−1}. By differentiating the trace of Equation (55) with respect to W and setting the result to zero, the following may be obtained:

W=σₓ²[Φ⁻¹G₀]*[I_{N}_{_{T}}−c₀^{T}]. (56)

By substituting Equation (56) into Equation (55), the following may be obtained:

E{εₙεₙ^{H}}=σₓ²[I_{N}_{_{T}}−c₀][I_{N}_{_{T}}−σₓ²G₀^{H}Φ⁻¹G₀][I_{N}_{_{T}}−c₀^{H}], (57)

and since f₀=W^{T}G₀=σₓ²[I_{N}_{_{T}}−c₀]G₀^{H}Φ⁻¹G₀, Equation (57) can be represented as

E{εₙεₙ^{II}}=σₓ²{[I_{N}_{_{T}}−c₀−f₀][I_{N}_{_{T}}−c₀^{II}]}. (58)

Finally, by combining Equation (51) with Equation (58), it can be established that

$$MMSE = tr \{ E \{ {ɛ}_{n} {ɛ}_{n}^{H} \} \} = {σ}_{x}^{2} {\sum }_{p = 1}^{{N}_{T}} ( 1 - {f}_{0 , pp} ) . \qquad ( 59 )$$

Accordingly, in one example of the present invention, the general expression for MMSE provided at 402 may be given by Equation (49). Method 400 may then proceed to 404, wherein the MMSE expression provided at 402 is related to symbol error and bit error probability and an upper bound is determined for the error probabilities by using modified Chernoff bounding. By way of non-limiting example, 404 may be performed as follows. Without loss of generality, the MMSE expression may be related to error probability by focusing on the performance of a p-th data stream. From Equation (49), the MSE of the p-th data stream can be determined as follows:

MMSEₚ=σₓ²[1−f_{0,pp}]. (60)

Then, according to Equations (49), (51), and (52), the equalized data of the p-th data stream can be given by:

$${z}_{n , p} = {f}_{0 , pp} {x}_{n , p} + {\sum }_{k = p + 1}^{{N}_{T}} {f}_{0 , pk} {x}_{n , k} + {\sum }_{m = B + 1}^{N - 1} {\sum }_{k = 1}^{{N}_{T}} {f}_{m , pk} {x}_{n - m , k} + {u}_{n , p} . \qquad ( 61 )$$

By defining α_{(.)}^{(r)} and α_{(.)}⁽ⁱ⁾ to be the real and imaginary parts of complex number α_{(.)}, Equation (61) can be represented as then (37) can be represented as follows:

$${z}_{n , p}^{( r )} = {f}_{0 , pp} {x}_{n , p}^{( r )} + {\sum }_{k = p + 1}^{{N}_{T}} ( {f}_{0 , pk}^{( r )} {x}_{n , k}^{( r )} - {f}_{0 , pk}^{( i )} {x}_{n , k}^{( i )} ) + {\sum }_{m = B + 1}^{N - 1} {\sum }_{k = 1}^{{N}_{T}} ( {f}_{m , pk}^{( r )} {x}_{n - m , k}^{( r )} - {f}_{m , pk}^{( i )} {x}_{n - m , k}^{( i )} ) + {u}_{n , p}^{( r )} \\ {z}_{n , p}^{( i )} = {f}_{0 , pp} {x}_{n , p}^{( i )} + {\sum }_{k = p + 1}^{{N}_{T}} ( {f}_{0 , pk}^{( i )} {x}_{n , k}^{( r )} + {f}_{0 , pk}^{( r )} {x}_{n , k}^{( i )} ) + {\sum }_{m = B + 1}^{N - 1} {\sum }_{k = 1}^{{N}_{T}} ( {f}_{m , pk}^{( i )} {x}_{n - m , k}^{( r )} + {f}_{m , pk}^{( r )} {x}_{n - m , k}^{( i )} ) + {u}_{n , p}^{( i )} a , \qquad ( 62 )$$

where f_{0,pp} is a real number as shown in Equation (60).

In one example, because there is not a rigorous and useful way to generally represent error probability with MMSE, 404 may be performed by utilizing a rectangular M-QAM constellation. In M-QAM constellations, decisions can be made independently on the real axis and the imaginary axis. Accordingly, Psₚ can be defined as the probability of a given symbol error rate for the p-th data stream. In addition, Psₚ^{(r)} and Psₚ⁽ⁱ⁾ can be respectively defined as the symbol error probabilities on the real and imaginary axes. In one example, the distribution of the information bits and the noise term are the same on the real and imaginary axe. Thus, Psₚ^{(r)}=Psₚ⁽ⁱ⁾ and Psₚ<2Psₚ⁽ⁱ⁾. From Equation (62), it can then be shown that the symbol error probability on the imaginary axis is given by:

$$\begin{matrix}{Ps}_{p}^{( i )} = \frac{2 ( \sqrt{M} - 1 )}{\sqrt{M}} Pr ( ξ + {u}_{n , p}^{( i )} \geq {f}_{0 , pp} ) , \\ where & ( 63 ) \\ ξ = {\sum }_{k = p + 1}^{{N}_{T}} ( {f}_{0 , pk}^{( i )} {x}_{n , k}^{( r )} + {f}_{0 , pk}^{( r )} {x}_{n , k}^{( i )} ) + {\sum }_{m = B + 1}^{N - 1} {\sum }_{k = 1}^{{N}_{T}} ( {f}_{m , pk}^{( i )} {x}_{n - m , k}^{( r )} + {f}_{m , pk}^{( r )} {x}_{n - m , k}^{( i )} ) . & ( 64 )\end{matrix}$$

The following upper bound can then be derived for Equation (64):

$$\begin{matrix}Pr ( ξ + {u}_{n , p}^{( i )} \geq {f}_{0 , pp} ) \leq \frac{1}{\sqrt{π} {σ}_{u , p}} exp \{ ϕ ( λ ) \} for all λ > 0 , \\ where & ( 65 ) \\ ϕ ( λ ) = ln ( exp ( \frac{1}{4} {σ}_{u , p}^{2} {λ}^{2} ) E \{ exp ( ξλ ) \} ) - ln ( λ ) - λ {f}_{0 , pp} & ( 66 )\end{matrix}$$

and σ_{u,p}² denotes the variance of u_{u,p} and is given by Equation (54). From Equation (65), the following may then be derived:

$$λ exp \{ ϕ ( λ ) \} < exp ( - {f}_{0 , pp} λ + \frac{1}{4} {σ}_{u , p}^{2} {λ}^{2} + \frac{1}{4} {σ}_{x , p}^{2} {λ}^{2} η ) for all λ > 0 , \qquad ( 67 )$$

where σ_{x,p}² is the variance of x_{n,p} and

$$η = ( {\sum }_{k = p + 1}^{{N}_{T}} {\vert {f}_{0 , pk} \vert}^{2} + {\sum }_{m = B + 1}^{N - 1} {\sum }_{k = 1}^{{N}_{T}} {\vert {f}_{m , pk} \vert}^{2} ) .$$

The optimal value that minimizes the upper bound in Equation (67), which may be defined as λₒₚₜ, may be determined by setting the derivative of the right-hand side of Equation (67) with respect to λ to zero and verifying that the second derivative of the equation is positive. By doing so, the following may be obtained:

$${λ}_{opt} = \frac{2 {f}_{0 , pp}}{{σ}_{u , p}^{2} + {σ}_{x , p}^{2} η} . \qquad ( 68 )$$

Next, the following may be derived from Equation (61):

MMSEₚ=σₐ²[1−f_{0,pp}]²+σ_{u,p}²+σ_{x,p}²η, (69)

and by substituting Equations (60) and (69) into Equations (68) and (67), it can be found that λₒₚₜ=2/MMSEₚ and:

$${λ}_{opt} exp \{ ϕ ( {λ}_{opt} ) \} < exp \{ - \frac{{f}_{0 , pp}^{2}}{{σ}_{u , p}^{2} + {σ}_{x , p}^{2} η} \} = exp \{ \frac{1}{{σ}_{x , p}^{2}} - \frac{1}{{MMSE}_{p}} \} . \qquad ( 70 )$$

By substituting λₒₚₜ and Equations (70) and (65) into Equation (63), the following upper bound on the symbol error rate Psₚ can be obtained:

$${Ps}_{p} < \frac{2 ( \sqrt{M} - 1 )}{\sqrt{M}} \frac{{MMSE}_{p}}{\sqrt{π} {σ}_{u , p}} exp \{ \frac{1}{{σ}_{x , p}^{2}} - \frac{1}{{MMSE}_{p}} \} . \qquad ( 71 )$$

Once the symbol error rate and its upper bound are determined, the bit error rate for the p-th data stream, which may be defined as Pbₚ, may be obtained by assuming Gray coding as follows:

$${Pb}_{p} \approx \frac{{Ps}_{p}}{{log}_{2} M} < \frac{2 ( \sqrt{M} - 1 )}{\sqrt{M} {log}_{2} M} \frac{{MMSE}_{p}}{\sqrt{π} {σ}_{u , p}} exp \{ \frac{1}{{σ}_{x , p}^{2}} - \frac{1}{{MMSE}_{p}} \} . \qquad ( 72 )$$

Additionally, the bit error rate of a MIMO system Pb, which may be defined as the average of the bit error rates of all N_{T} data streams within the system, can be determined as follows:

$$Pb = \frac{1}{{N}_{T}} {\sum }_{p = 1}^{{N}_{T}} {Pb}_{p} < \frac{1}{{N}_{T}} {\sum }_{p = 1}^{{N}_{T}} \frac{2 ( \sqrt{M} - 1 )}{\sqrt{M} {log}_{2} M} \frac{{MMSE}_{p}}{\sqrt{π} {σ}_{u , p}} exp \{ \frac{1}{{σ}_{x , p}^{2}} - \frac{1}{{MMSE}_{p}} \} . \qquad ( 73 )$$

From Equation (73), it can be seen that the value in the exponential function dominates the error bound. In addition, it can be seen from Equation (60) that MMSEₚ is less than σ_{x,p}² since f_{0,pp} is a positive real number and MMSE is larger than zero. Thus, systems with larger MMSE may also have a larger error probability. Finally, after MMSE is related to error probability and an upper bound is determined for the error probability at 404, method 406 may optionally proceed to 406. At 406, by varying the parameters in the resulting error bound determined at 404, the bound can be made applicable to SISO, MISO, and SIMO systems employing receive equalization. In general, the bound determined at 404 will generally be very close to true simulation results, thereby making it a useful tool for system analysis and evaluation.

In accordance with another aspect of the present invention, the computational complexities of the FDE-NP scheme utilized by receiver structure 200 and the FDE-NP-SIC scheme utilized by receiver structure 300 are compared to the conventional FD-LE and FD-DFE schemes for MIMO systems in Table 1 as follows, where N_{T} represents the number of transmitted streams, N_{R} represents the number of receive antennas, N represents the length of the symbols in each block, and B represents the number of the orders of feedback filters in the FD-DFE, FDE-NP, and FDE-NP-SIC schemes.

TABLE 1
Complexity Comparison for Different FDE Schemes.

| Structure | Equalization Complexity | Coefficient Calculation Complexity |
|---|---|---|
| FD-LE | $( {N}_{T} + {N}_{R} ) \frac{N}{2} {log}_{2} N + {NN}_{T} {N}_{R}$ | N[O(N³_{R}) + N²_{T}N_{R} + N_{T}N²_{R}] |
| FD-DFE | $( {N}_{T} + {N}_{R} ) \frac{N}{2} {log}_{2} N + {NN}_{T} {N}_{R} + {NBN}_{T}^{2}$ | N(O(N³_{T}) + O(N³_{R})) + BO(N³_{T}) +(2B² + 2B − 3)N³_{T} + ((N − 1)B + NN_{R})N_{T}N_{R} +((N − 1)(N_{R} + 1)B + 2NN_{R})N²_{T} |
| FDE-NP | $( {N}_{T} + {N}_{R} ) \frac{N}{2} {log}_{2} N + {NN}_{T} {N}_{R} + {NBN}_{T}^{2}$ | N(O(N³_{T}) + O(N³_{R})) + BO(N³_{T}) +(2B² + 2B − 3)N³_{T} + NN_{T}N²_{R} +((N − 1)B + 2NN_{R})N²_{T} |
| FDE-NP-SIC | $( {N}_{T} + {N}_{R} ) \frac{N}{2} {log}_{2} N + {NN}_{T} {N}_{R} + {NBN}_{T}^{2} + N \frac{{N}_{T} ( {N}_{T} - 1 )}{2}$ | $N ( O ( {N}_{T}^{3} ) + O ( {N}_{R}^{3} ) ) + BO ( {N}_{T}^{3} ) + \\ ( 2 {B}^{2} + 3 B - 3 ) {N}_{T}^{3} + {NN}_{T} {N}_{R}^{2} + \\ ( ( N - 1 ) B + 2 {NN}_{R} ) {N}_{T}^{2} + B \frac{{N}_{T}^{3} - {N}_{T}^{2}}{2}$ |

The complexities given in Table 1 are quantified in terms of the number of complex multiplications per block. Because linear FDE and FDE with decision feedback perform channel estimation with a similar amount of computations, channel estimation complexity is omitted from Table 1. Further, the total number of multiplications for each structure is divided in Table 1 into equalization and coefficient calculation computations. As used in Table 1, the coefficients of the conventional FD-LE structure are given in Equation (14). Further, the coefficients of the feedforward FDE and the feedback NPs of the FDE-NP structure 200 are respectively given in Equations (14) and (18), and the coefficients of the feedforward FDE and the feedback NPs of the FDE-NP-SIC structure 300 are respectively given in Equations (14) and (43). In addition, the coefficients of the feedforward FDE of the conventional FD-DFE structure are provided in Equation (47), while the calculation of coefficients for the feedback filters requires substantially the same amount of operations as the FDE-NP structure 200.

It should also be appreciated that the FDE-NP-SIC structure 300 does not bring additional complex multiplication operations since the data streams utilized by said structure are ordered according to MMSE_{LE}, which is given by Equation (45), and calculating Γₖ⁻¹ in Equation (45) is also required for the coefficients of the NPs. Further, it should be appreciated that Equation (18) belongs to the multi-dimension Yule-Walker equation and that this equation can accordingly be solved by using the extended Levinson algorithm, which is recursive and requires 4BN_{T}³+O(N_{T}³) complex multiplications for the derivation of the solution of [c₁ . . . C_{B}]^{H} from order B to B+1. Moreover, it should be appreciated that the number of multiplications required for Cholesky factorization of a D×D square matrix is in the order of O(D³)

It can be observed from Table 1 that the FD-LE structure has the least operation complexity because of its lack of a feedback design. However, because the FD-LE structure lacks a feedback design, it also performs more poorly than the other structures. In addition, it can be observed from Table 1 that both the FD-DFE and FDE-NP structures have the same complexity in equalization. However, the FDE-NP structure 200 requires less computational complexity in calculating coefficients since the coefficients of the feedforward FDE 220 in the FDE-NP structure 200 are independent of the coefficients of the NPs 240 and instead are similar to those of the FD-LE structure, while the coefficients of the feedforward FDE in the FD-DFE structure are related to the coefficients of the feedback filters. As a non-limiting example, an exemplary system in which equalization is employed may have S=2, R=2, N=64 and B=2. In such a system, the conventional FD-LE and FD-DFE structures respectively require about 3.6×10³ and 8.3×10³ complex multiplications. However, the FDE-NP structure 200 and the FDE-NP-SIC structure 300 require only 6.8×10³ and 6.9×10³ complex multiplications, which corresponds to 82% and 83% of the requirements of the FD-DFE structure, respectively.

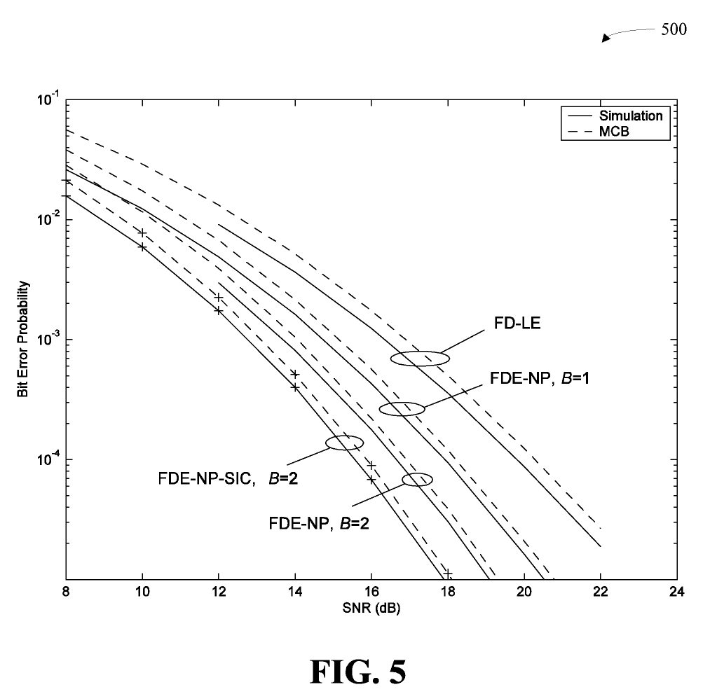

Referring now to FIG. 5, a graph 500 is provided that illustrates performance data for an exemplary MIMO system with equalization in accordance with an aspect of the present invention. More particularly, graph 500 illustrates performance data for an exemplary MIMO system (e.g. a system 100) having two data streams and two receive antennas (e.g., receive antennas 22). At the transmitter (e.g. the transmitter 10), 64 independent uncoded QPSK symbols can be packed in one block for each data stream. The receiver (e.g. the receiver 20) and the transmitter can communicate over a frequency selective channel that may be defined as an 8-ray exponential delay profile uncorrelated Rayleigh fading channel having a time delay between the closest rays equal to one symbol. Further, a cyclic prefix having a minimum length can be inserted in front of each block. In one example, each channel has a fixed impulse response for each block period. Additionally, it may be assumed that the receiver has perfect synchronization and channel estimation and that the feedback symbols are always correct.

Graph 500 illustrates several bit error rate (BER) results corresponding to different orders B of NPs (e.g., NPs 240) in the FDE-NP structure 200. When B is equal to zero, it can be seen that the performance of the FDE-NP structure is substantially the same as that of the conventional FD-LE scheme. Graph 500 further illustrates that system performance can be greatly improved even with only 2 feedback symbols from each data stream. For example, at a bit error rate of 10⁻⁴, the FDE-NP structure 200 and the FDE-NP-SIC structure 300 respectively give improvements of approximately 3 dB and 4 dB over the conventional FD-LE scheme. It should also be appreciated that the performance of the FDE-NP scheme utilized by receiver structure 200 is substantially similar to that of the conventional FD-DFE scheme when both schemes have the same number of feedback taps. Further, it should be appreciated from Table 1 that the FDE-NP scheme utilized by receiver structure 200 and the FDE-NP-SIC scheme utilized by receiver structure 300 may require nearly 20% less operation complexity than that required by the FD-DFE scheme when the order of the feedback filters is 2. In addition, graph 500 illustrates the curves of the BER upper bound for each equalization scheme. From graph 500, it can be seen that the upper bound provided by modified Chernoff bounding (MCB) in method 400 is very close to the data obtained from Monte Carlo simulation. Accordingly, graph 500 shows that method 400 can be a useful alternative for evaluation and analysis of a studied system.

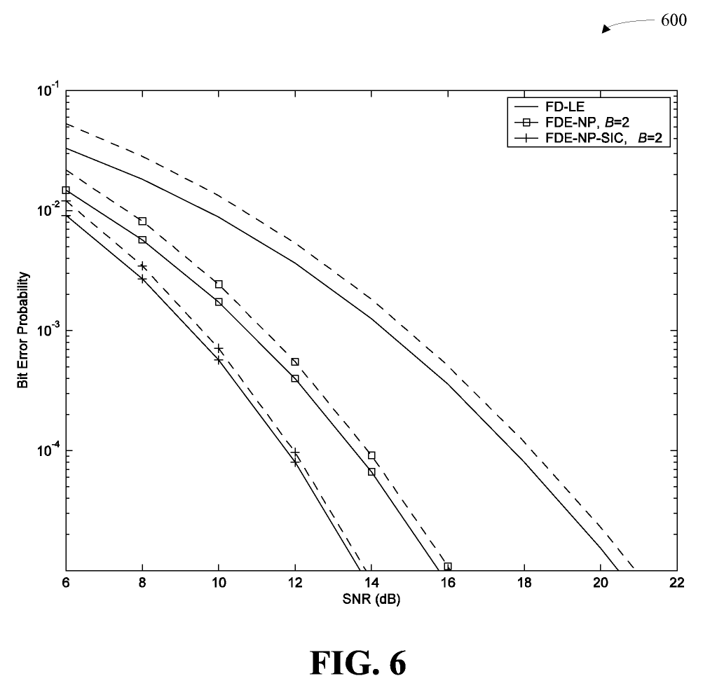

Turning briefly to FIG. 6, a graph 600 is provided that illustrates a comparison between the performance of the conventional FD-LE scheme, the FDE-NP scheme utilized by receiver structure 200, and the FDE-NP-SIC scheme utilized by receiver structure 300 in a 4-by-4 MIMO system. In one example, the system communicates over the same frequency selective channel that was used for graph 500 and QPSK modulation is considered. As illustrated by graph 600, a system with more receive antennas can achieve a higher diversity order. Further, graph 600 illustrates that the BER bound obtained by method 400 can become closer to the Monte Carlo results as the diversity order increases. By comparing graph 600 to graph 500, it can also be seen that the performance improvement of the FDE-NP-SIC structure 300 over the FDE-NP structure 200 becomes larger in the 4-by-4 MIMO system illustrated by graph 600 since more interferences can be cancelled with SIC processing.

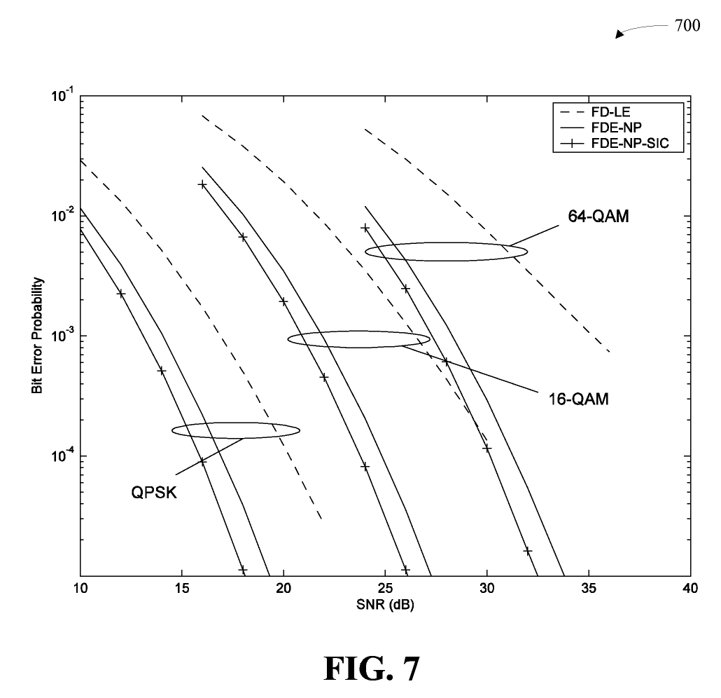

Referring now briefly to FIG. 7, a graph 700 is provided that illustrates a comparison between the performance of the conventional FD-LE scheme, the FDE-NP scheme utilized by receiver structure 200, and the FDE-NP-SIC scheme utilized by receiver structure 300 for different modulation constellations in the same 2-by-2 MIMO system used for graph 500. Specifically, three modulation constellations—QPSK, 16-QAM and 64-QAM—are considered in graph 700, and the order of NPs is fixed at 2. As illustrated by graph 700, the performance improvement of the FDE-NP scheme utilized by receiver structure 200 over the conventional FD-LE scheme becomes larger as the modulation order increases. For example, at a bit error rate of 10⁻³, the FDE-NP scheme gives improvements of more than 2 dB, 4 dB and 6 dB over the conventional FD-LE scheme for QPSK, 16-QAM and 64-QAM, respectively. Further, graph 700 illustrates that the performance improvement of the FDE-NP-SIC scheme utilized by receiver structure 300 over the FDE-NP scheme is almost the same for each of the three modulation cases.

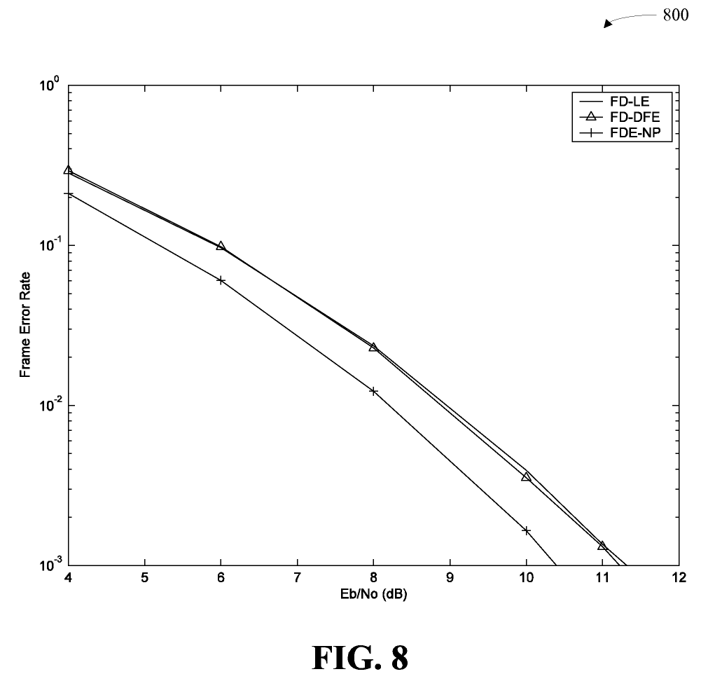

Referring to FIG. 8, a graph 800 is provided that illustrates a comparison between the conventional FD-LE scheme, the conventional FD-DFE scheme, and the FDE-NP scheme utilized by receiver structure 200. The same 2-by-2 MIMO system used for graph 500 is considered in graph 800, with the exceptions that each block consists of 256 symbols and channel coding is utilized wherein a standard convolutional code with code rate ½, constraint length 5, and octal generator polynomials (23, 35) is applied. The coded bits are mapped to QPSK symbols, which are written into a 32×8 row-column block interleaver column-by-column and read out row-by-row for modulation. In the non-limiting example illustrated by graph 800, the length of the trace back window of the Viterbi decoder is set to be 26, which is more than five times that of the constraint length, to ensure reliable feedback. It should be appreciated that the length of the trace back window is set to be less than the column length (i.e., 32) of the deinterleaver so that there is enough time for the decoder to provide reliable feedback.

Graph 800 illustrates the frame error rate performance as a function of E_{b}/N₀ for the different receiver structures. As illustrated in graph 800, the curve for FD-LE corresponds to the basic linear FDE scheme followed by a Viterbi decoder. Further, the curve for FD-DFE represents the performance of the conventional FD-DFE scheme that uses hard decisions as feedbacks. In addition, the curve for FDE-NP represents the result of the FDE-NP scheme with the processing method utilized by receiver structure 200 with feedback noise predictor 240₂. For each of the illustrated schemes with feedback processing, the order of feedback filters is set to one, meaning that one previous decided symbol of each data stream is fed back to eliminate ISI and CCI. In the exemplary FDE-NP scheme illustrated by graph 800, the symbols in the first column of the deinterleaver 243 are linearly equalized as there is no feedback information available for them. As can be seen from graph 800, the performance of the conventional FD-DFE scheme is almost the same as that of FD-LE even though FD-DFE utilizes feedback processing and FD-LE does not. This can be attributed to the fact that hard decisions prior to decoding have high unreliability. In contrast, graph 800 illustrates that the exemplary FDE-NP scheme that may be implemented in accordance with an aspect of the present invention can achieve better performance than linear FDE without a significant increase in complexity. For example, at a frame error rate of 10⁻³, the illustrated FDE-NP scheme gives an improvement of around 1.0 dB over the linear FDE scheme with one-order NPs. This improvement in performance over linear FDE is due to the fact that the feedback utilized in the FDE-NP scheme comes from the decoder and has very high reliability. Further, it should be appreciated that the performance of the FDE-NP scheme may be improved even further when more decoded symbols are available for feedback. In addition, it should be appreciated that the performance/complexity tradeoff can be easily achieved in the FDE-NP scheme by only changing the coefficients of the NPs without changing the coefficients of the feedforward FDE.

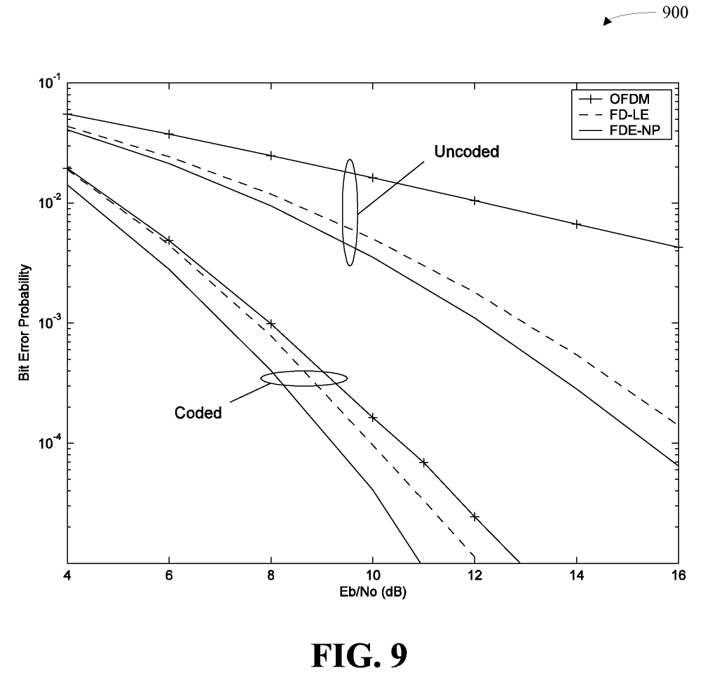

Referring now to FIG. 9, a graph 900 is provided that illustrates a comparison between the performance of FDE-MIMO systems, specifically MIMO systems utilizing FD-LE and FDE-NP schemes for equalization, and that of OFDM-MIMO systems for both uncoded and coded cases. For the FDE-NP scheme (e.g. an FDE-NP scheme provided by receiver structure 200), one-order NPs (e.g., NPs 240) are considered. Further, the number of symbols for each system is set to 256. For the FDE-NP scheme in the uncoded case, instead of assuming that the feedback symbols are correct as in graph 500, the detected symbols for ISI and CCI cancellation are used. For the illustrated OFDM-MIMO systems, an MMSE MIMO receiver is considered. In the coded case, the system parameters considered for graph 900 are the same as those considered for graph 600 for FDE-MIMO. Additionally, in the illustrated OFDM-MIMO systems, block interleaving is done at the bit level by first interleaving the codewords in a 32×16 block first and then mapping the codewords to QPSK symbols. By doing so, the illustrated OFDM-MIMO systems may better achieve frequency diversity. Thus, for the illustrated OFDM-MIMO system in the coded case, an MMSE receiver is first used to equalize the signals from different antennas, and then the equalized signals are decomposed to bit-level signals and passed to the deinterleaver and the decoder. From simulation, it can also be observed that the performance difference of FDE-MIMO between bit interleaving and symbol interleaving is small.

As illustrated by graph 900, the illustrated FDE-MIMO systems have more diversity order in the uncoded case than the illustrated OFDM-MIMO system. This can be attributed to the fact that decisions in FDE systems are based on the signal energy transmitted over the entire channel bandwidth. Furthermore, frequency diversity in a FDE-MIMO system can be achieved after equalization in the frequency domain. This is in contrast to OFDM-MIMO systems, where sub-carriers that suffer from deep fading will primarily determine the error rate. On the other hand, graph 900 illustrates that the two system types have similar performance in the coded case since frequency diversity can be achieved in the OFDM-MIMO system by coding within the OFDM sub-carriers. However, it can be seen from graph 900 that even the illustrated FD-LE-MIMO scheme always performs better than the illustrated OFDM-MIMO scheme. Additionally, it has been shown that the comparison between FDE and OFDM for a MIMO system illustrated by graph 900 is consistent with similar results in SISO systems. It should also be appreciated that the receive scheme in the simulated OFDM-MIMO is not the optimal scheme. In contrast, pursuant to the near-optimal method of BICM-OFDM for MIMO systems, the log-likelihood ratio value of each bit is first found, and then maximum a posteriori (MAP) decoding is performed based on that value. However, while receive scheme will have much better performance, it requires high computational complexity, especially when the number of multiple antennas and the size of modulation constellations increases. Graph 900 instead compares the performance of OFDM-MIMO and FDE-MIMO schemes with substantially the same comparable computational complexity order.

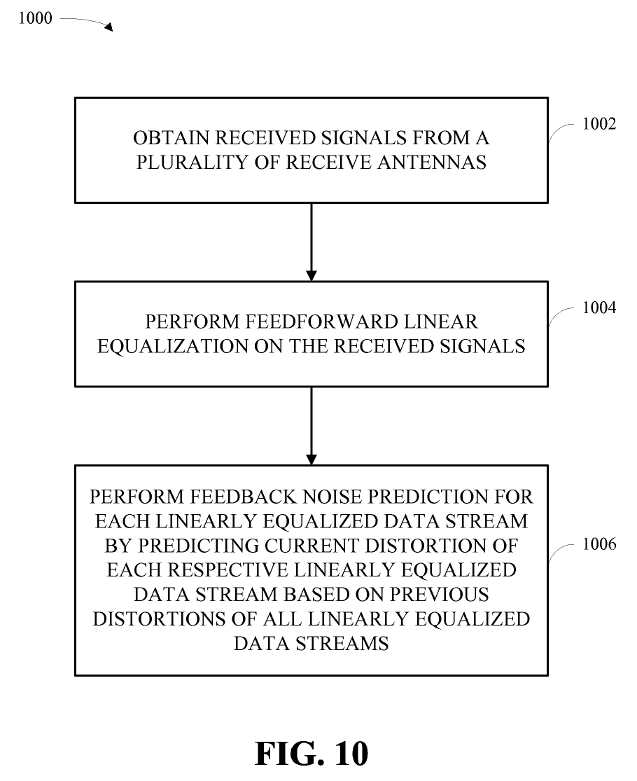

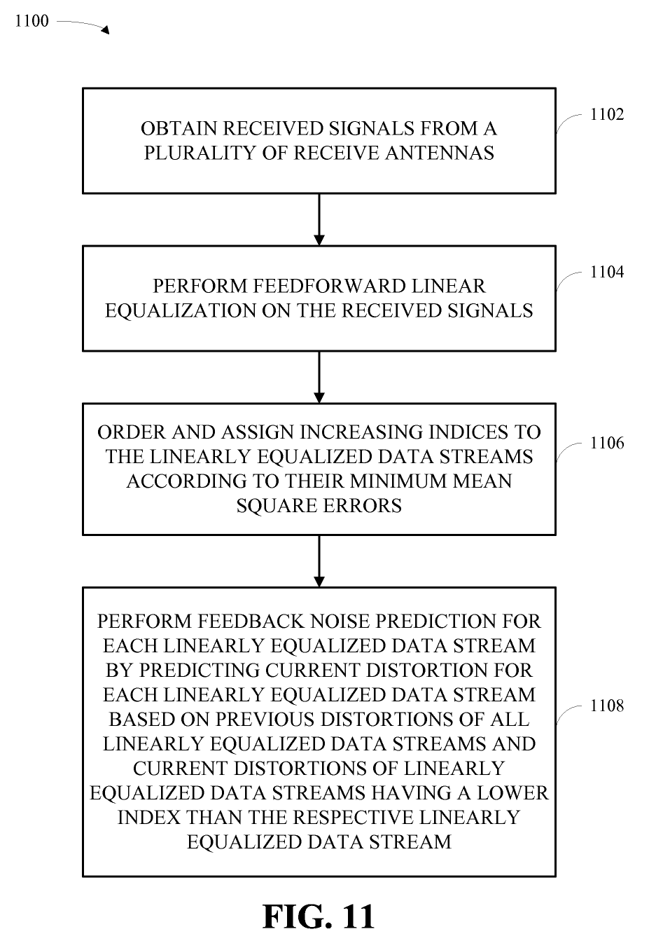

Turning to FIGS. 10-11, additional methodologies that may be implemented in accordance with the present invention are illustrated. While, similar to method 400, the methodologies illustrated in FIGS. 10-11 are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement the methodologies in accordance with the present invention.

Referring to FIG. 10, a method 1000 of hybrid time-frequency domain equalization with noise prediction in a MIMO communication system (e.g., a system 100) in accordance with an aspect of the present invention is illustrated. At 1002, received signals are obtained from a plurality of receive antennas (e.g., receive antennas 22 at a receiver 20), which may be used to retrieve data streams that are transmitted from one or more transmit antennas (e.g. transmit antennas 12 at a transmitter 10). At 1004, feedforward linear equalization is performed on the received signals (e.g., by a feedforward FDE 220). The feedforward equalization at 1004 may be performed in the frequency domain by, for example, performing a DFT operation on the received signals prior to equalization. At 1006, feedback noise prediction is performed for each linearly equalized data stream (e.g., by a feedback noise predictor 240) by predicting a distortion for each linearly equalized data stream based on previous distortions of all linearly equalized data streams. The noise prediction at 1006 may be performed in the time domain by, for example, performing an IDFT operation on the resulting linearly equalized data from 1004.

Referring now to FIG. 11, a method 1100 of hybrid time-frequency domain equalization with noise prediction and successive interference cancellation in a MIMO communication system (e.g., a system 100) in accordance with an aspect of the present invention is illustrated. At 1102, received signals are obtained from a plurality of receive antennas (e.g., receive antennas 22 at a receiver 20), which may be used to retrieve data streams that are transmitted from one or more transmit antennas (e.g. transmit antennas 12 at a transmitter 10). At 1104, feedforward linear equalization is performed on the received signals (e.g., by a feedforward FDE 320). The feedforward equalization at 1104 may be performed in the frequency domain by, for example, performing a DFT operation on the received signals prior to equalization. At 1106, the linearly equalized data streams are ordered (e.g., by an ordering component 340) and assigned increasing indices according to their MMSEs. The linearly equalized data streams may be ordered at 1106 in the time domain by, for example, performing an IDFT operation on the resulting linearly equalized data streams from 1104. Finally, at 1108, feedback noise prediction is performed for each linearly equalized data stream (e.g., by a feedback noise predictor 350) by predicting current distortion for each respective current data stream based on previous distortions of all linearly equalized data streams as well as current distortions of linearly equalized data streams having a lower index than each respective linearly equalized data stream.

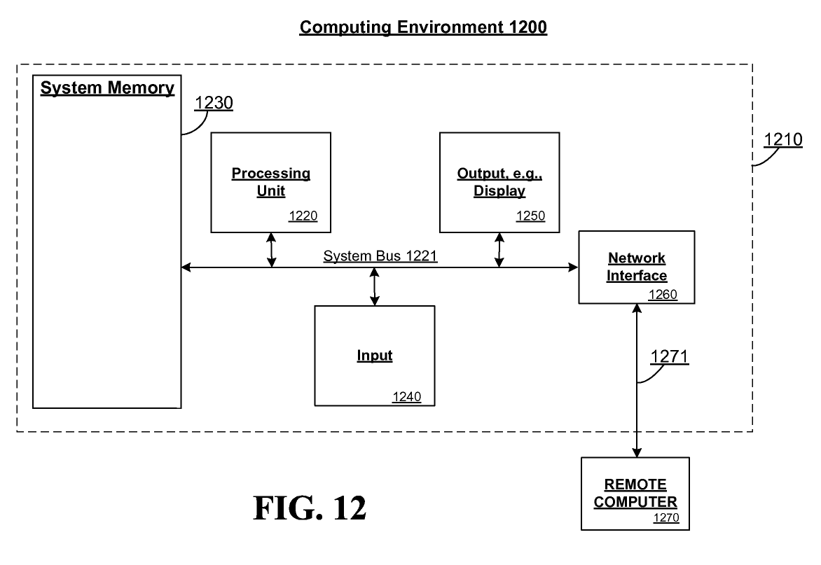

Turning to FIG. 12, an exemplary non-limiting computing system or operating environment in which the present invention may be implemented is illustrated. One of ordinary skill in the art can appreciate that handheld, portable and other computing devices and computing objects of all kinds are contemplated for use in connection with the present invention, i.e., anywhere that a communications system may be desirably configured. Accordingly, the below general purpose remote computer described below in FIG. 12 is but one example of a computing system in which the present invention may be implemented.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 12 thus illustrates an example of a suitable computing system environment 1200 in which the invention may be implemented, although as made clear above, the computing system environment 1200 is only one example of a suitable computing environment for a media device and is not intended to suggest any limitation as to the scope of use or functionality of the invention. Neither should the computing environment 1200 be interpreted as having any dependency or requirement relating to any one or combination of components illustrated in the exemplary operating environment 1200.

With reference to FIG. 12, an example of a computing environment 1200 for implementing the invention includes a general purpose computing device in the form of a computer 1210. Components of computer 1210 may include, but are not limited to, a processing unit 1220, a system memory 1230, and a system bus 1221 that couples various system components including the system memory to the processing unit 1220. The system bus 1221 may be any of several types of bus structures including a memory bus or memory controller, a peripheral bus, and a local bus using any of a variety of bus architectures.

Computer 1210 typically includes a variety of computer readable media. Computer readable media can be any available media that can be accessed by computer 121 0. By way of example, and not limitation, computer readable media may comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media typically embodies computer readable instructions, data structures, program modules or other data in a modulated data signal such as a carrier wave or other transport mechanism and includes any information delivery media.

The system memory 1230 may include computer storage media in the form of volatile and/or nonvolatile memory such as read only memory (ROM) and/or random access memory (RAM). A basic input/output system (BIOS), containing the basic routines that help to transfer information between elements within computer 1210, such as during start-up, may be stored in memory 1230. Memory 1230 typically also contains data and/or program modules that are immediately accessible to and/or presently being operated on by processing unit 1220. By way of example, and not limitation, memory 1230 may also include an operating system, application programs, other program modules, and program data.

The computer 1210 may also include other removable/non-removable, volatile/nonvolatile computer storage media. For example, computer 1210 could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1221 through a non-removable memory interface such as an interface, and a magnetic disk drive or optical disk drive is typically connected to the system bus 1221 by a removable memory interface, such as an interface.

A user may enter commands and information into the computer 1210 through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1220 through user input 1240 and associated interface(s) that are coupled to the system bus 1221, but may be connected by other interface and bus structures, such as a parallel port, game port or a universal serial bus (USB). A graphics subsystem may also be connected to the system bus 1221. A monitor or other type of display device is also connected to the system bus 1221 via an interface, such as output interface 1250, which may in turn communicate with video memory. In addition to a monitor, computers may also include other peripheral output devices such as speakers and a printer, which may be connected through output interface 1250.

The computer 1210 may operate in a networked or distributed environment using logical connections to one or more other remote computers, such as remote computer 1270, which may in turn have media capabilities different from device 1210. The remote computer 1270 may be a personal computer, a server, a router, a network PC, a peer device or other common network node, or any other remote media consumption or transmission device, and may include any or all of the elements described above relative to the computer 1210. The logical connections depicted in FIG. 12 include a network 1271, such local area network (LAN) or a wide area network (WAN), but may also include other networks/buses. Such networking environments are commonplace in homes, offices, enterprise-wide computer networks, intranets and the Internet.

When used in a LAN networking environment, the computer 1210 is connected to the LAN 1271 through a network interface or adapter. When used in a WAN networking environment, the computer 1210 typically includes a communications component, such as a modem, or other means for establishing communications over the WAN, such as the Internet. A communications component, such as a modem, which may be internal or external, may be connected to the system bus 1221 via the user input interface of input 1240, or other appropriate mechanism. In a networked environment, program modules depicted relative to the computer 1210, or portions thereof, may be stored in a remote memory storage device. It will be appreciated that the network connections shown and described are exemplary and other means of establishing a communications link between the computers may be used.

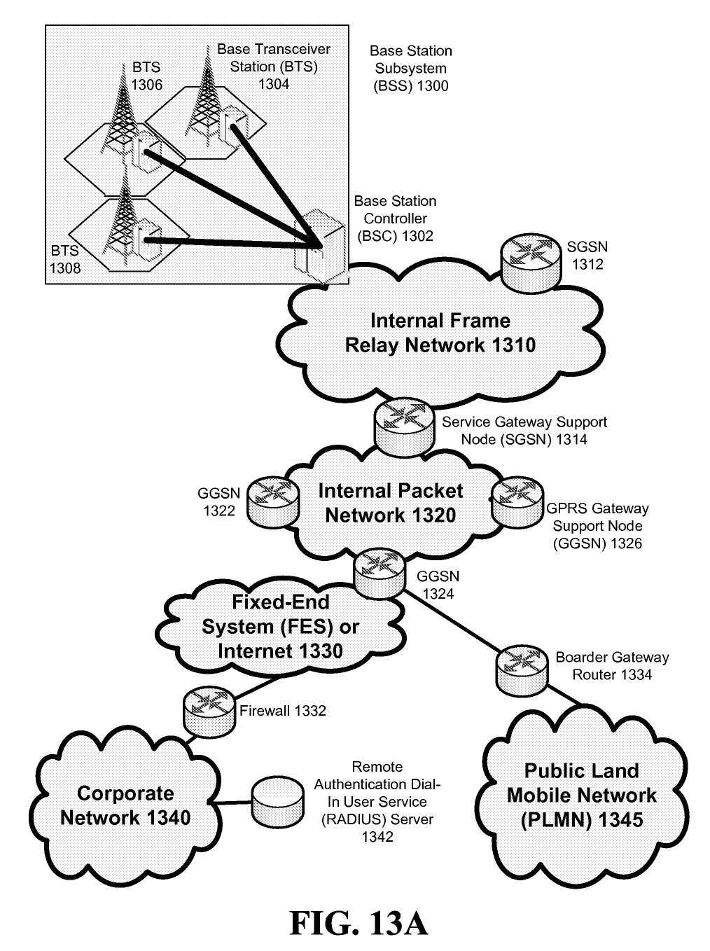

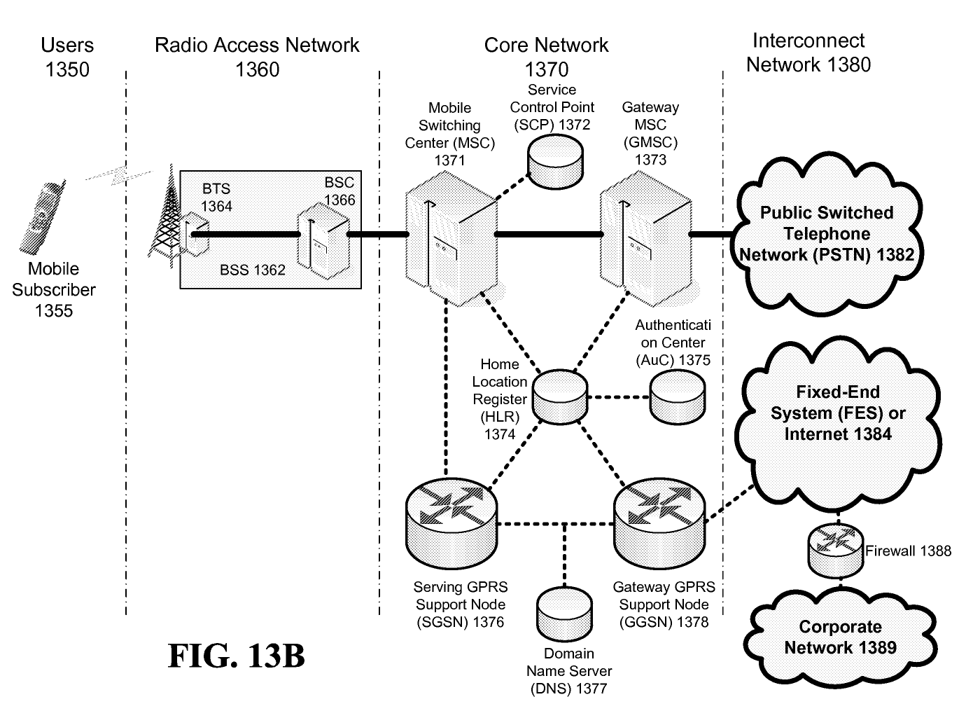

Turning now to FIGS. 13A-B, an overview of a network environment suitable for service by embodiments of the invention is illustrated. The above-described systems and methodologies for channel equalization may be applied to any network; however, the following description sets forth some exemplary telephony radio networks and non-limiting operating environments for the present invention. The below-described operating environments should be considered non-exhaustive, however, and thus the below-described network architecture is merely one network architecture into which the present invention may be incorporated. It is to be appreciated that the invention may be incorporated into any now existing or future alternative architectures for communication networks as well.

The global system for mobile communication (“GSM”) is one of the most widely utilized wireless access systems in today's fast growing communications systems. GSM provides circuit-switched data services to subscribers, such as mobile telephone or computer users. General Packet Radio Service (“GPRS”), which is an extension to GSM technology, introduces packet switching to GSM networks. GPRS uses a packet-based wireless communication technology to transfer high and low speed data and signaling in an efficient manner. GPRS optimizes the use of network and radio resources, thus enabling the cost effective and efficient use of GSM network resources for packet mode applications.

As one of ordinary skill in the art can appreciate, the exemplary GSM/GPRS environment and services described herein can also be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1x Evolution Data Optimized (“EVDO”), Code Division Multiple Access-2000 (“cdma2000 3x”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that shall become available in time. In this regard, the techniques of the invention may be applied independently of the method of data transport, and does not depend on any particular network architecture, or underlying protocols.

FIG. 13A depicts an overall block diagram of an exemplary packet-based mobile cellular network environment, such as a GPRS network, in which the invention may be practiced. In such an environment, there are a plurality of Base Station Subsystems (“BSS”) 1300 (only one is shown), each of which comprises a Base Station Controller (“BSC”) 1302 serving a plurality of Base Transceiver Stations (“BTS”) such as BTSs 1304, 1306, and 1308. BTSs 1304, 1306, 1308, etc., are the access points where users of packet-based mobile devices become connected to the wireless network. In exemplary fashion, the packet traffic originating from user devices is transported over the air interface to a BTS 1308, and from the BTS 1308 to the BSC 1302. Base station subsystems, such as BSS 1300, are a part of internal frame relay network 1310 that may include Service GPRS Support Nodes (“SGSN”) such as SGSN 1312 and 1314. Each SGSN is in turn connected to an internal packet network 1320 through which a SGSN 1312, 1314, etc., can route data packets to and from a plurality of gateway GPRS support nodes (GGSN) 1322, 1324, 1326, etc. As illustrated, SGSN 1314 and GGSNs 1322, 1324, and 1326 are part of internal packet network 1320. Gateway GPRS serving nodes 1322, 1324 and 1326 mainly provide an interface to external Internet Protocol (“IP”) networks such as Public Land Mobile Network (“PLMN”) 1345, corporate intranets 1340, or Fixed-End System (“FES”) or the public Internet 1330. As illustrated, subscriber corporate network 1340 may be connected to GGSN 1324 via firewall 1332; and PLMN 1345 is connected to GGSN 1324 via boarder gateway router 1334. The Remote Authentication Dial-In User Service (“RADIUS”) server 1342 may be used for caller authentication when a user of a mobile cellular device calls corporate network 1340.

Generally, there can be four different cell sizes in a GSM network—macro, micro, pico and umbrella cells. The coverage area of each cell is different in different environments. Macro cells can be regarded as cells where the base station antenna is installed in a mast or a building above average roof top level. Micro cells are cells whose antenna height is under average roof top level; they are typically used in urban areas. Pico cells are small cells having a diameter is a few dozen meters; they are mainly used indoors. On the other hand, umbrella cells are used to cover shadowed regions of smaller cells and fill in gaps in coverage between those cells.

FIG. 13B illustrates the architecture of a typical GPRS network as segmented into four groups: users 1350, radio access network 1360, core network 1370, and interconnect network 1380. Users 1350 comprise a plurality of end users (though only mobile subscriber 1355 is shown in FIG. 13B). Radio access network 1360 comprises a plurality of base station subsystems such as BSSs 1362, which include BTSs 1364 and BSCs 1366. Core network 1370 comprises a host of various network elements. As illustrated here, core network 1370 may comprise Mobile Switching Center (“MSC”) 1371, Service Control Point (“SCP”) 1372, gateway MSC 1373, SGSN 1376, Home Location Register (“HLR”) 1374, Authentication Center (“AuC”) 1375, Domain Name Server (“DNS”) 1377, and GGSN 1378. Interconnect network 1380 also comprises a host of various networks and other network elements. As illustrated in FIG. 13B, interconnect network 1380 comprises Public Switched Telephone Network (“PSTN”) 1382, Fixed-End System (“FES”) or Internet 1384, firewall 1388, and Corporate Network 1389.

A mobile switching center can be connected to a large number of base station controllers. At MSC 1371, for instance, depending on the type of traffic, the traffic may be separated in that voice may be sent to Public Switched Telephone Network (“PSTN”) 1382 through Gateway MSC (“GMSC”) 1373, and/or data may be sent to SGSN 1376, which then sends the data traffic to GGSN 1378 for further forwarding.

When MSC 1371 receives call traffic, for example, from BSC 1366, it sends a query to a database hosted by SCP 1372. The SCP 1372 processes the request and issues a response to MSC 1371 so that it may continue call processing as appropriate.

The HLR 1374 is a centralized database for users to register to the GPRS network. HLR 1374 stores static information about the subscribers such as the International Mobile Subscriber Identity (“IMSI”), subscribed services, and a key for authenticating the subscriber. HLR 1374 also stores dynamic subscriber information such as the current location of the mobile subscriber. Associated with HLR 1374 is AuC 1375. AuC 1375 is a database that contains the algorithms for authenticating subscribers and includes the associated keys for encryption to safeguard the user input for authentication.

In the following, depending on context, the term “mobile subscriber” sometimes refers either to the end user or to the actual portable device used by an end user of the mobile cellular service. When a mobile subscriber turns on his or her mobile device, the mobile device goes through an attach process by which the mobile device attaches to an SGSN of the GPRS network. In FIG. 13B, when mobile subscriber 1355 initiates the attach process by turning on the network capabilities of the mobile device, an attach request is sent by mobile subscriber 1355 to SGSN 1376. The SGSN 1376 queries another SGSN, to which mobile subscriber 1355 was attached before, for the identity of mobile subscriber 1355. Upon receiving the identity of mobile subscriber 1355 from the other SGSN, SGSN 1376 requests more information from mobile subscriber 1355. This information is used to authenticate mobile subscriber 1355 to SGSN 1376 by HLR 1374. Once verified, SGSN 1376 sends a location update to HLR 1374 indicating the change of location to a new SGSN, in this case SGSN 1376. HLR 1374 notifies the old SGSN, to which mobile subscriber 1355 was attached before, to cancel the location process for mobile subscriber 1355. HLR 1374 then notifies SGSN 1376 that the location update has been performed. At this time, SGSN 1376 sends an Attach Accept message to mobile subscriber 1355, which in turn sends an Attach Complete message to SGSN 1376.

After attaching itself with the network, mobile subscriber 1355 then goes through the authentication process. In the authentication process, SGSN 1376 sends the authentication information to HLR 1374, which sends information back to SGSN 1376 based on the user profile that was part of the user's initial setup. The SGSN 1376 then sends a request for authentication and ciphering to mobile subscriber 1355. The mobile subscriber 1355 uses an algorithm to send the user identification (ID) and password to SGSN 1376. The SGSN 1376 uses the same algorithm and compares the result. If a match occurs, SGSN 1376 authenticates mobile subscriber 1355.

Next, the mobile subscriber 1355 establishes a user session with the destination network, corporate network 1389, by going through a Packet Data Protocol (“PDP”) activation process. Briefly, in the process, mobile subscriber 1355 requests access to the Access Point Name (“APN”), for example, UPS.com (e.g., which can be corporate network 1379) and SGSN 1376 receives the activation request from mobile subscriber 1355. SGSN 1376 then initiates a Domain Name Service (“DNS”) query to learn which GGSN node has access to the UPS.com APN. The DNS query is sent to the DNS server within the core network 1370, such as DNS 1377, which is provisioned to map to one or more GGSN nodes in the core network 1370. Based on the APN, the mapped GGSN 1378 can access the requested corporate network 1379. The SGSN 1376 then sends to GGSN 1378 a Create Packet Data Protocol (“PDP”) Context Request message that contains necessary information. The GGSN 1378 sends a Create PDP Context Response message to SGSN 1376, which then sends an Activate PDP Context Accept message to mobile subscriber 1355.

Once activated, data packets of the call made by mobile subscriber 1355 can then go through radio access network 1360, core network 1370, and interconnect network 1380, in particular fixed-end system or Internet 1384 and firewall 1388, to reach corporate network 1389.

The present invention has been described herein by way of examples. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Additionally, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture,” “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, according to various permutations and combinations of the foregoing. Sub-components can also be implemented as components communicatively coupled to other components rather than included within parent components, e.g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

What is claimed is:

1. A system that facilitates channel equalization in a multiple-input multiple-output communication system, comprising:
a feedforward frequency domain equalizer (FDE) that identifies a plurality of transmitted data streams from a plurality of received signals by linearly equalizing the plurality of received signals; and
one or more feedback noise predictors that predict distortion(s) of respective linearly equalized data streams based at least in part on past distortions associated therewith.

2. The system of claim 1, wherein each of the one or more feedback noise predictors comprises:
a noise prediction component that predicts distortion of a linearly equalized data stream based at least in part on past distortions of the plurality of linearly equalized data streams; and
a detector that identifies a transmitted data stream in a resulting equalized data stream, the resulting equalized data stream is obtained by canceling the predicted distortion from the linearly equalized data stream.

3. The system of claim 1, further comprising a plurality of receive antennas that receive the plurality of transmitted data streams.

4. The system of claim 3, wherein the receive antennas receive the plurality of transmitted data streams according to a single-carrier block transmission scheme.

5. The system of claim 4, wherein each of the transmitted data streams is coded according to a channel code and comprises one or more interleaved blocks, and each of the one or more feedback noise predictors comprises:
a deinterleaver that buffers respective blocks in a transmitted data stream and facilitates noise prediction for data in the blocks according to a non-interleaved sequence of the data;
a decoder that identifies and decodes the data in the blocks of the transmitted data stream based at least in part on the channel code; and
a noise prediction component that predicts distortion of a linearly equalized data stream based at least in part on feedback corresponding to the decoded data.

6. The system of claim 1, further comprising an ordering component that orders the linearly equalized data streams identified by the feedforward FDE based on minimum mean square errors (MMSEs) of the data streams, wherein the one or more feedback noise predictors predict distortion of the respective linearly equalized data streams based at least in part on past distortions associated therewith and current distortions associated with linearly equalized data streams having a lower MMSE than a respective linearly equalized data stream for which distortion is being predicted.

7. The system of claim 6, wherein each of the one or more feedback noise predictors comprises:
a noise prediction component that predicts distortion of a linearly equalized data stream based at least in part on past distortions of the plurality of linearly equalized data streams and current distortions of linearly equalized data streams having a lower MMSE than the linearly equalized data stream for which distortion is being predicted; and
a detector that detects a transmitted data stream in a resulting equalized data stream, the resulting equalized data stream is obtained by canceling the predicted distortion from the linearly equalized data stream.

8. The system of claim 1, wherein the feedforward FDE and the one or more feedback noise predictors are independently designed and independently modifiable.

9. A packet-based mobile cellular network environment employing the system of claim 1.

10. A method for channel equalization in a multiple-input multiple-output communication system, comprising:
identifying a plurality of transmitted data streams based on a plurality of received signals;
linearly equalizing the plurality of received signals; and
performing noise prediction for respective linearly equalized data streams at least in part by predicting current distortion(s) for the linearly equalized data streams based on past distortions of the linearly equalized data streams.

11. The method of claim 10, wherein the identifying the plurality of transmitted data streams includes receiving the received signals in the time domain and converting the received signals to the frequency domain using a discrete Fourier transform (DFT) operation, the linearly equalizing the plurality of received signals includes linearly equalizing the plurality of received signals in the frequency domain, and the performing noise prediction includes converting the linearly equalized data streams to the time domain using an inverse discrete Fourier transform (IDFT) operation and performing noise prediction for the respective linearly equalized data streams in the time domain.

12. The method of claim 11, wherein the DFT operation is implemented based on a fast Fourier transform (FFT) algorithm and the IDFT operation is implemented based on an inverse fast Fourier transform (IFFT) algorithm.

13. The method of claim 10, further comprising assigning increasing indices to the plurality of linearly equalized data streams, wherein the performing noise prediction includes performing noise prediction for respective linearly equalized data streams at least in part by predicting current distortion(s) of the linearly equalized data streams based on past distortions of the linearly equalized data streams and current distortions of linearly equalized data streams having a lower index than the respective linearly equalized data streams.

14. The method of 13, wherein the assigning increasing indices includes assigning increasing indices to the plurality of linearly equalized data streams based on MMSEs of the linearly equalized data streams.

15. The method of claim 10, further comprising analyzing the performance of the channel equalization at least in part by determining an upper bound for one or more of a symbol error rate and a bit error rate for the communication system, wherein the determining an upper bound includes relating an expression for MMSE of the communication system to one or more of the symbol error rate and the bit error rate and determining an upper bound for one or more of the symbol error rate and the bit error rate at least in part by using a modified Chernoff bounding algorithm.

16. The method of claim 10, further comprising:
obtaining a resulting data stream by canceling predicted current distortion(s) from a linearly equalized data stream; and
retrieving a transmitted data stream in the resulting data stream.

17. A computer readable medium comprising computer executable instructions for performing the method of claim 10.

18. An apparatus that performs channel equalization in a multiple-input multiple-output communication system, comprising:
means for linearly equalizing a plurality of received signals by using feedforward frequency domain equalization; and
means for predicting current distortion for a linearly equalized data stream based at least in part on past distortions of the plurality of linearly equalized data streams.

19. The apparatus of claim 18, further comprising means for ordering the plurality of linearly equalized data streams based at least in part on MMSEs of the linearly equalized data streams, wherein the means for predicting current distortion for a linearly equalized data stream includes means for predicting current distortion for the linearly equalized data stream based at least in part on past distortions of the plurality of linearly equalized data streams and current distortions of data streams in the plurality of linearly equalized data streams having a lower MMSE than the data stream for which distortion is being predicted.

20. The apparatus of claim 18, further comprising means for analyzing the performance of the communication system by determining an upper bound for one or more of a symbol error rate and a bit error rate for the communication system based at least in part on a modified Chernoff bounding algorithm.
